(19) United States
(12) Patent Application Publication
(10) Pub. No.: US 2026/0120146 A1
(43) Pub. Date: Apr. 30, 2026

(54) INFORMATION PROCESSING DEVICE, INFORMATION PROCESSING METHOD, AND STORAGE MEDIUM

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventor: Tomoyuki HOTTA, Machida Tokyo (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/421,135

(22) Filed: Dec. 16, 2025

Related U.S. Application Data
(63) Continuation of application No. PCT/JP2024/015318, filed on Apr. 17, 2024.

(30) Foreign Application Priority Data
Jun. 20, 2023 (JP) 2023-100879

(51) Int. Cl. G06Q 30/0251; G06T 7/70; G06V 10/40; G06V 10/774; G06V 20/52; G06V 40/20; H04W 64/00

(52) U.S. Cl. CPC G06Q 30/0261; G06Q 30/0267; G06T 7/70; G06V 10/40; G06V 10/774; G06V 20/52; G06V 40/20; H04W 64/00; G06T 2207/10016; G06T 2207/20081; G06T 2207/30196; G06T 2207/30236

(57) ABSTRACT

According to an embodiment, an information processing device includes a first acquirer, a second acquirer, a first identifier, a second identifier, and an associator. The first acquirer acquires first information about a user based on first detection information detected by a first detection device. The second acquirer acquires second information including second detection information detected by a second detection device and user identification information for identifying the user. The first identifier identifies a first calculated position of the user based on the first detection information. The second identifier identifies a second calculated position of the user based on the second detection information. The associator associates the user identification information with the first information based on the first calculated position and the second calculated position.

### CROSS-REFERENCE TO RELATED APPLICATION

The present application claims priority based on Japanese Patent Application No. 2023-100879 filed Jun. 20, 2023 and PCT/JP2024/015318 filed Apr. 17, 2024, the contents of which are incorporated herein by reference.

### FIELD

Embodiments of the present invention relate to an information processing device, an information processing method, and a program.

### BACKGROUND

In commercial facilities and the like, states of behaviors or gazes of customers and the like may be observed to estimate preferences of customers, which can be used as a reference when product development, content of advertisements for products to be provided to customers, and the like are determined. The positions of the customers are detected by sensors using beacons, image processing, and the like. However, because customers move around various positions within a commercial facility, a small number of sensors may not be able to track all customers within the commercial facility, making it difficult to continuously identify the positions of the customers and other users.

### BRIEF DESCRIPTION OF THE DRAWINGS

FIG. 1 is a diagram showing an example of an information processing system 1 according to a first embodiment.

FIG. 2 is a diagram showing a schematic overview of a process in which a user P shops at a commercial facility M.

FIG. 3 is a diagram showing an example of a hardware configuration of a user terminal 20.

FIG. 4 is a diagram showing an example of a hardware configuration of a payment processing device 30 according to the first embodiment.

FIG. 5 is a diagram showing an example of a hardware configuration of an information processing device 100 according to the first embodiment.

FIG. 6 is a diagram showing an example of a functional configuration of a user terminal 20 according to the first embodiment.

FIG. 7 is a diagram showing an example of a functional configuration of a payment processing device 30 according to the first embodiment.

FIG. 8 is a diagram showing an example of a functional configuration of the information processing device 100 according to the first embodiment.

FIG. 9 is a flowchart showing an example of a process of the information processing device 100 of the first embodiment.

FIG. 10 is a perspective view showing an example of a situation within a commercial facility.

FIG. 11 is a view of an example of a situation within the commercial facility, when viewed from above.

FIG. 12 is a perspective view showing an example of a situation within a commercial facility according to a second embodiment.

FIG. 13 is a perspective view showing another example of the situation within the commercial facility according to the second embodiment.

FIG. 14 is a perspective view showing an example of the interior of an elevator according to a third embodiment.

FIG. 15 is a perspective view showing another example of the interior of the elevator according to the third embodiment.

FIG. 16 is a diagram showing an example of an information processing system including an information processing device according to a fourth embodiment.

FIG. 17 is a diagram showing an example of a hardware configuration of a payment processing device 400 according to the fourth embodiment.

FIG. 18 is a diagram showing an example of a hardware configuration of an information processing device 500 according to the fourth embodiment.

FIG. 19 is a diagram showing an example including a functional configuration of the payment processing device 400 according to the fourth embodiment.

FIG. 20 is a diagram showing an example including a functional configuration of the information processing device 500 according to the fourth embodiment.

FIG. 21 is a flowchart showing an example of a process of the information processing device 500 according to the fourth embodiment.

FIG. 22 is a flowchart showing an example of a process of the payment processing device 400.

FIG. 23 is a view showing an example of a situation in which a user is making a payment using a payment processing device, viewed from the periphery.

FIG. 24 is a view showing an example of a situation in which the user is making a payment using the payment processing device, viewed from the periphery.

FIG. 25 is a view showing an example of a situation in which a first user P1 is gazing at a tablet 410 displaying a face-extracted image.

FIG. 26 is a view showing another example of a situation in which the user is making a payment using the payment processing device, viewed from the periphery.

FIG. 27 is a view showing an example of a situation in which the first user P1 is gazing at the tablet 410 displaying a face-including image.

### DETAILED DESCRIPTION

Hereinafter, an information processing device, an information processing system, an information processing method, and a storage medium of embodiments will be described with reference to the drawings.

According to an embodiment, an information processing device includes a first acquirer, a second acquirer, a first identifier, a second identifier, and an associator. The first acquirer acquires first information about a user based on first detection information detected by a first detection device. The second acquirer acquires second information including second detection information detected by a second detection device and user identification information for identifying the user. The first identifier identifies a first calculated position of the user based on the first detection information. The second identifier identifies a second calculated position of the user based on the second detection information. The associator associates the user identification information with the first information based on the first calculated position and the second calculated position.

### First Embodiment

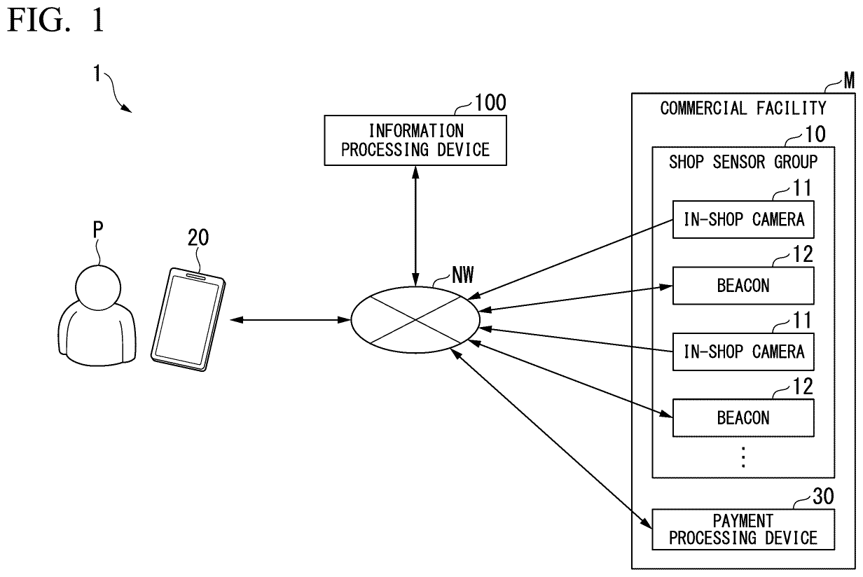

An overall configuration of an information processing system 1 according to a first embodiment will be described. FIG. 1 is a diagram showing an example of the information processing system 1 according to the first embodiment. The information processing system 1 includes, for example, a shop sensor group 10, a user terminal 20, a payment processing device 30, and an information processing device 100. The shop sensor group 10 and the payment processing device 30 are installed within a commercial facility M, and the user terminal 20 is possessed, for example, by a user P.

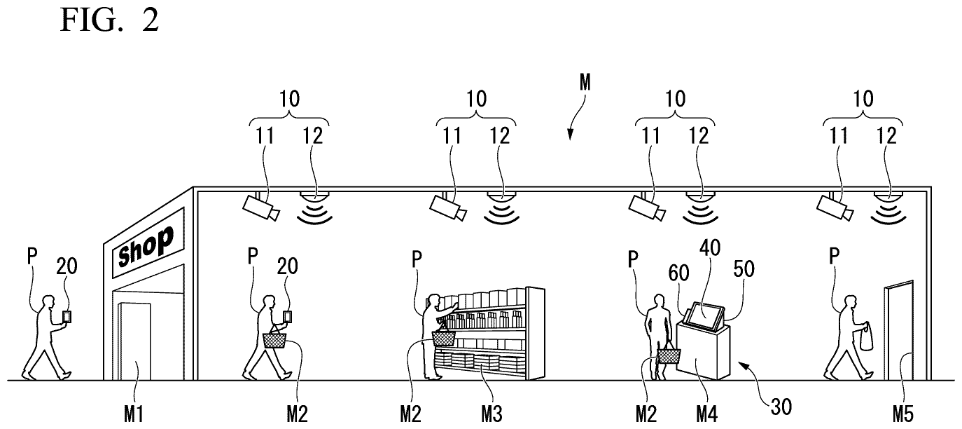

The information processing system 1 is, for example, a system to be used by the user P when shopping or the like is performed within the commercial facility M. Therefore, before the details of the information processing system 1 are described, an arrangement of constituent elements of the information processing system 1 within the commercial facility M and the like will be described. FIG. 2 is a diagram showing a schematic overview of a process by which the user P performs shopping at the commercial facility M.

The shop sensor group 10 for collecting information about the user P is provided in the commercial facility M. The shop sensor group 10 includes, for example, a plurality of in-shop cameras 11 and a plurality of beacons 12. The plurality of in-shop cameras 11 and the plurality of beacons 12 are installed at a plurality of positions inside and outside the commercial facility M.

The user P first enters the commercial facility M through an entrance gate M1. For example, the user P holds the user terminal 20 in his or her hand as he or she passes through the entrance gate M1. The user terminal 20 is a device, such as a smartphone, that is possessed and carried by each of a plurality of users P.

The in-shop camera 11 and the beacon 12 are also installed at the entrance gate M1. When the user P enters the commercial facility M through the entrance gate M1, the user terminal 20 transmits entry information to the information processing device 100 using a beacon signal. The information processing device 100 having received the entry information receives and acquires image information of an image of the user P captured by the in-shop camera 11.

The user P enters the commercial facility M and picks up a shopping basket M2. The user P continues shopping while holding the shopping basket M2 and the user terminal 20. During this time, the user P may, for example, hold the user terminal 20 in his or her hand, place the user terminal 20 in the shopping basket M2, or store the user terminal 20 in his or her clothing pocket. Examples of the commercial facility M include department shops, shopping malls, supermarkets, and retail shops.

As the user P continues shopping, for example, the user P may pick up products displayed on a display shelf M3 and put the products into the shopping basket M2. The display shelf M3 is equipped with a weight sensor that detects a weight of the products displayed on the display shelf M3. The weight sensor transmits weight information about the detected product weight to the information processing device 100. After putting desired products into the shopping basket M2, the user P moves to a register M4, where the payment processing device 30 is installed, and makes the payment to purchase the products.

The payment processing device 30 includes, for example, a tablet 40, a housing unit 50, and a holder 60. The tablet 40 is housed in the holder 60 attached to the housing unit 50 and placed on the register M4. The tablet 40 can be removed from the holder 60 and separated from the housing unit 50 for use.

The payment processing device 30 may be operated by an employee of the commercial facility M, by the user P himself or herself, or by both the employee of the commercial facility M and the user P. Employees of the commercial facility M, for example, carry employee terminals distributed thereto. The employee terminals are, for example, smartphones. The employee terminals may also be portable phones, tablets, or the like.

After the payment is completed using the payment processing device 30, the user P exits the commercial facility M through an exit gate M5. The beacon 12 is also installed at the exit gate M5. When the user P exits the commercial facility M through the exit gate M5, the user terminal 20 uses a beacon signal to transmit exit information to the information processing device 100.

Returning to FIG. 1, the shop sensor group 10, the user terminal 20, the payment processing device 30, and the information processing device 100 are connected to each other via a network NW in an aspect in which they can communicate with each other. The network NW may be an intranet, a local area network (LAN), a wireless LAN, or the like, and preferably has a certain level of information security.

The in-shop camera 11 in the shop sensor group 10 is installed, for example, on the ceiling of the commercial facility M. The in-shop camera 11 may be installed on, for example, a wall of the commercial facility M, the display shelf M3, a register, the payment processing device 30, or the like, other than the ceiling. The in-shop camera 11 images the commercial facility M. The in-shop camera 11 may image outside of the commercial facility M (outdoors). The in-shop camera 11 transmits image information about the captured images to the information processing device 100.

The in-shop camera 11 is, for example, a digital camera that captures digital images. The in-shop camera 11 may also be an analog camera other than a digital camera. When the in-shop camera 11 is an analog camera, the in-shop camera 11 may include an analog-to-digital (A/D) converter that digitizes an analog image.

The beacon 12 is installed, for example, on the ceiling of the commercial facility M, attached to a lighting fixture. The beacon 12 is provided, for example, adjacent to the in-shop camera 11. The beacon 12 may be installed in a position other than the ceiling, or independently of the lighting fixtures and the in-shop cameras 11. The beacon 12 may be provided, for example, on the wall of the commercial facility M, the display shelf M3, the register, the payment processing device 30, or the like.

The beacon 12 transmits and receives an electrical signal (hereinafter referred to as a beacon signal) using information communication that utilizes telecommunications technology. Examples of information communication using telecommunications technology include ultra-wideband (UWB), Bluetooth (registered trademark), Wi-Fi, near field communication (NFC), and the like.

The beacon 12 has a function of receiving a beacon signal transmitted by a first beacon signal transmitter/receiver 27 installed in the user terminal 20, and a function of transmitting a beacon signal to the user terminal 20. When the beacon signal transmitted by the first beacon signal transmitter/receiver 27 is received, the beacon 12 generates relative position information indicating a relative position of the user terminal 20 (user P) for the beacon 12 and transmits the relative position information to the information processing device 100. The beacon 12 transmits beacon signals, for example, at regular time intervals. The relative position information is an example of information included in the second information, which will be described below.

The information processing device 100 acquires first detection information, for example, image information, detected by a first detection device, such as, for example, the in-shop camera 11. The information processing device 100 acquires first information about the user based on the transmitted first detection information, for example, behavior information about the user's behavior. The information processing device 100 acquires second detection information detected by a second detection device, such as the beacon 12 or the user terminal 20, for example, relative position information indicating the relative position between the beacon 12 and the user terminal 20.

The information processing device 100 acquires information about the user P (hereinafter referred to as user information) transmitted by the second detection device along with the relative position information. The user information is stored, for example, in the user terminal 20. The user information includes information about a user ID assigned to the user P, the user's age, and the user's gender. The user information may also include other information about the user, such as an address, an occupation, a family structure, and a place of employment. The user terminal 20 transmits the user information to the information processing device 100 directly or via the beacon 12. The user ID is an example of user identification information. The user information is an example of information included in the second information, which will be described below.

The information processing device 100 identifies a first calculated position of the user P based on first detection information and identifies a second calculated position of the user P based on second detection information. The first calculated position is, for example, a position identified by image processing of image information, and the second calculated position is an absolute position identified based on relative position information in relation to the user and information about the absolute position of the beacon 12. The second calculated position is a position calculated with less load than the first calculated position.

The information processing device 100 associates the acquired behavior information with the user information based on the first calculated position and the second calculated position. The information processing device 100 estimates target-of-interest information about a target of interest of the user based on the user's behavior information, and generates information based on the target-of-interest information, for example, auxiliary information for assisting in purchasing products or advertising information about advertisements of products, or identifies products the user plans to purchase (hereinafter referred to as “purchase target products”).

In the user terminal 20, for example, a shopping application is installed. The shopping application is an application program for providing information provision services, including price information provision services and advertising provision services, to the user P shopping at the shop M. The user terminal 20 functions as a part of the information processing system 1, for example, when the shopping application is activated.

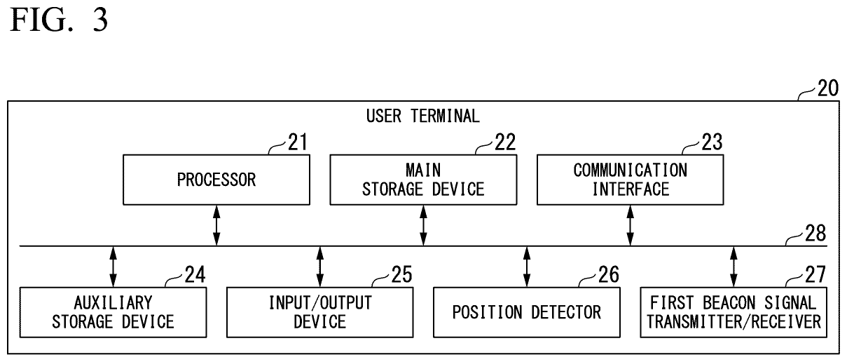

Next, a hardware configuration of each device in the information processing system 1 according to the first embodiment will be described. First, the hardware configuration of the user terminal 20 will be described. FIG. 3 is a diagram showing an example of the hardware configuration of the user terminal 20. The user terminal 20 includes, for example, a processor 21, a main storage device 22, a communication interface 23, an auxiliary storage device 24, an input/output device 25, a position detector 26, a first beacon signal transmitter/receiver 27, and a bus 28.

The processor 21 is, for example, a central processing unit (CPU), and reads and executes a terminal control program, for example, a shopping application, stored in the main storage device 22, to implement each function of the user terminal 20. Moreover, the processor 21 may read and execute programs other than the terminal control program to implement functions necessary to implement each function provided in the user terminal 20.

The main storage device 22 is, for example, a random-access memory (RAM), and pre-stores the terminal control program and other programs that are read and executed by the processor 21. The main storage device 22 also stores user information for the user P, who possesses the user terminal 20.

The communication interface 23 is an interface circuit for communicating with the information processing device 100, the payment processing device 30, and the like. The auxiliary storage device 24 is, for example, a hard disk drive (HDD), a solid-state drive (SSD), a flash memory, or a read-only memory (ROM).

The input/output device 25 is, for example, a touch panel display. The input/output device 25 receives an input of information about the use of the information provision service provided by the shopping application, for example, in accordance with an operation from the user P. Information provided to the user P by the shopping application and information about the user P's shopping is displayed on the input/output device 25. The input/output device 25 may be configured as separate input and output devices.

The position detector 26 is, for example, a global navigation satellite system (GNSS) device represented by a global positioning system (GPS). The position detector 26 detects the position of the user terminal 20. The position detector 26 measures a position of its own device based on radio waves received from, for example, GNSS satellites.

Like the beacon 12, the first beacon signal transmitter/receiver 27 transmits and receives beacon signals using information communication that utilizes telecommunications technology. The first beacon signal transmitter/receiver 27 has a function of receiving a beacon signal transmitted by the beacon 12 installed in the commercial facility M and a function of transmitting a beacon signal to the beacon 12 and the payment processing device 30.

When the beacon signal transmitted by the beacon 12 is received, the first beacon signal transmitter/receiver 27 generates relative position information indicating the relative position of the user terminal 20 (user P) for the beacon 12 and transmits the relative position information to the information processing device 100. The first beacon signal transmitter/receiver 27 transmits beacon signals, for example, at regular time intervals.

The bus 28 connects the processor 21, the main storage device 22, the communication interface 23, the auxiliary storage device 24, the input/output device 25, the position detector 26, and the first beacon signal transmitter/receiver 27 so that they can transmit and receive data to and from each other.

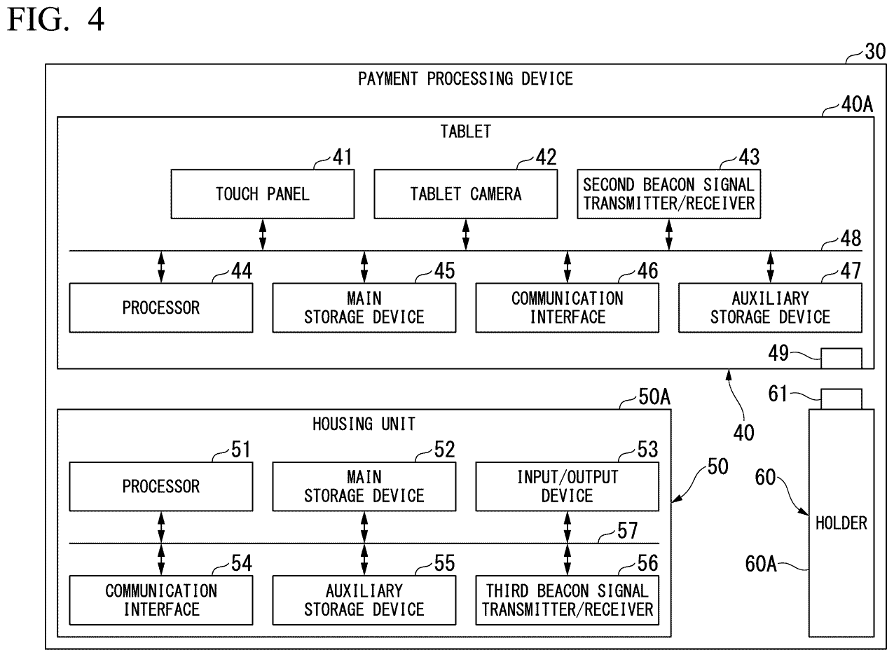

Next, a hardware configuration of the payment processing device 30 according to the first embodiment will be described with reference to FIG. 4. FIG. 4 is a diagram showing an example of the hardware configuration of the payment processing device 30 according to the first embodiment. The tablet 40 in the payment processing device 30 includes, for example, a tablet housing 40A, a touch panel 41, a tablet camera 42, a second beacon signal transmitter/receiver 43, a processor 44, a main storage device 45, a communication interface 46, an auxiliary storage device 47, a bus 48, a tablet housing 40A, and a first connector 49.

The housing unit 50 includes, for example, a housing 50A, a processor 51, a main storage device 52, an input/output device 53, a communication interface 54, an auxiliary storage device 55, a third beacon signal transmitter/receiver 56, and a bus 57. The holder 60 includes, for example, a holder body 60A and a second connector 61. The second connector 61 is provided on the holder body 60A. The second connector 61 is, for example, a male connector. The holder body 60A is capable of housing the tablet 40.

The touch panel 41 has functions of a display and an input interface. The touch panel 41 displays various information of a graphical user interface (GUI) and the like. The touch panel 41 is an input interface to which information can be input. For example, the user P or a seller can input various information by operating the GUI to be displayed on the touch panel 41. In addition to the touch panel 41, the tablet 40 has input/output devices such as a microphone and a speaker.

The tablet camera 42 is an optical camera. The tablet camera 42 captures an image including the face of the user P in the surrounding area, for example, scenery in front of the tablet 40 when the user is positioned directly in front of the tablet 40. The tablet camera 42 is arranged in a position where its imaging range includes the face of the user P, who will make a payment using the payment processing device 30. For example, when the user P is positioned in front of the tablet 40, the tablet camera 42 captures an image including the user P's face. When the tablet camera 42 is directed toward two-dimensional codes, the tablet camera 42 captures images of these two-dimensional codes.

The second beacon signal transmitter/receiver 43 is a transmitter that transmits a beacon signal using information communication that utilizes telecommunications technology. The second beacon signal transmitter/receiver 43 is a receiver that receives beacon signals transmitted by the user terminal 20 using information communication that utilizes telecommunications technology, like the first beacon signal transmitter/receiver 27.

When a beacon signal transmitted by the first beacon signal transmitter/receiver 27 has been received, the second beacon signal transmitter/receiver 43 generates relative position information indicating a relative position of the user terminal 20 (user P) for the payment processing device 30 and transmits the generated relative position information to the information processing device 100. The second beacon signal transmitter/receiver 43 transmits beacon signals, for example, at regular time intervals. When a beacon signal transmitted by the second beacon signal transmitter/receiver 43 has been received, the first beacon signal transmitter/receiver 27 generates relative position information indicating the relative position of the user terminal 20 (user P) for the payment processing device 30 and transmits the generated relative position information to the information processing device 100.

The processor 44 is, for example, a CPU, and reads and executes a payment processing device control program to implement various functions of the payment processing device 30, such as product registration, payment, authentication, and intention confirmation. The processor 44 may also read and execute programs other than the payment processing device control program to implement functions necessary to implement the various functions of the payment processing device 30.

The main storage device 45 is, for example, a RAM, and pre-stores the payment processing device control program and other programs that are read and executed by the processor 44. The main storage device 45 provides the stored payment processing device control program to the processor 44, for example, in accordance with a read process of the processor 44.

The communication interface 46 is an interface circuit for communicating with the user terminal 20, the payment processing device 30, and the like via the network NW or other networks. The auxiliary storage device 47 is, for example, a hard disk drive, a solid-state drive, a flash memory, or a ROM.

The bus 48 connects the touch panel 41, the tablet camera 42, the second beacon signal transmitter/receiver 43, the processor 44, the main storage device 45, the communication interface 46, the auxiliary storage device 47, and the first connector 49 so that they can transmit and receive data to and from each other. The first connector 49 is, for example, a female connector. The first connector 49 can be connected with a second connector 61 provided in the holder 60. The first connector 49 may be a male connector and the second connector 61 may be a female connector.

The processor 51, the main storage device 52, the input/output device 53, the communication interface 54, the auxiliary storage device 55, the third beacon signal transmitter/receiver 56, and the bus 57 housed in the housing 50A have configurations similar to those of the processor 44, the main storage device 45, the communication interface 46, the auxiliary storage device 47, the second beacon signal transmitter/receiver 43, and the bus 48 of the tablet 40. The processors, the main storage devices, the input/output devices, the communication interfaces, and the auxiliary storage devices in the housing 50A and the tablet 40 may function independently or in cooperation with each other.

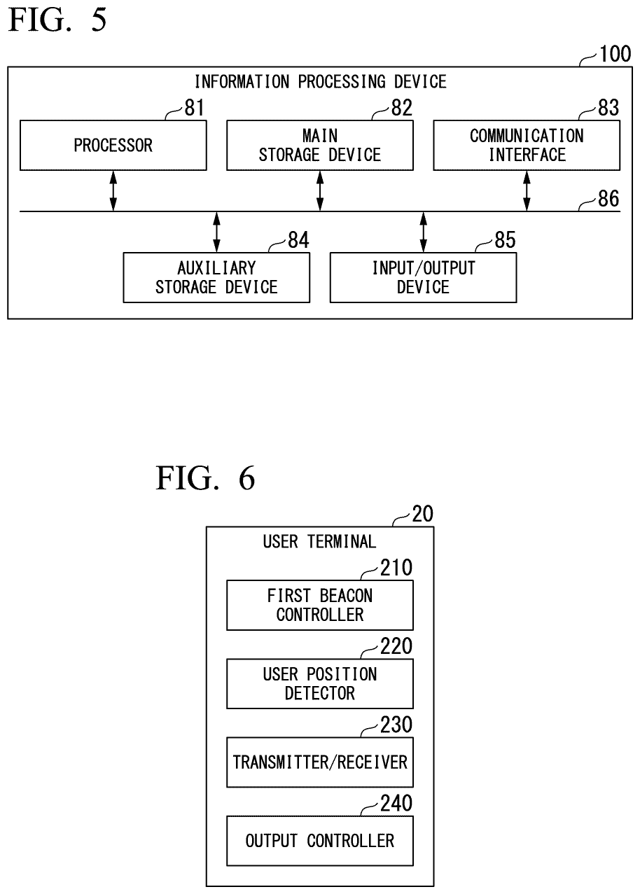

Next, a hardware configuration of the information processing device 100 will be described. FIG. 5 is a diagram showing an example of the hardware configuration of the information processing device 100 according to the first embodiment. The information processing device 100 includes, for example, a processor 81, a main storage device 82, a communication interface 83, an auxiliary storage device 84, an input/output device 85, and a bus 86.

The processor 81 is, for example, a CPU, and reads and executes an information provision program to implement the various functions provided in the information processing device 100. Moreover, the processor 81 may read and execute programs other than the information provision program to implement functions necessary to implement the various functions provided in the information processing device 100. The main storage device 82 is, for example, a RAM, and pre-stores shop terminal control and information provision programs and other programs that are read and executed by the processor 81.

The communication interface 83 is an interface circuit for communicating with the user terminal 20, the payment processing device 30, and the like via the network NW. The auxiliary storage device 84 is, for example, a hard disk drive, a solid-state drive, a flash memory, or a ROM.

The input/output device 85 is, for example, a touch panel display. The input/output device 85 may separately include an input device such as a mouse or a keyboard, and an output device such as a display. The bus 86 connects the processor 81, the main storage device 82, the communication interface 83, the auxiliary storage device 84, and the input/output device 85 so that they can transmit and receive data to and from each other.

Next, a functional configuration of the processing device in the information processing system 1 will be described. First, the user terminal 20 will be described. FIG. 6 is a diagram showing an example of a functional configuration of the user terminal 20 according to the first embodiment. The user terminal 20 includes, for example, a first beacon controller 210, a user position detector 220, a transmitter/receiver 230, and an output controller 240.

The first beacon controller 210, for example, causes the first beacon signal transmitter/receiver 27 to transmit beacon signals at regular intervals. The first beacon controller 210 acquires a beacon signal transmitted by the beacon 12 or the payment processing device 30 and received by the first beacon signal transmitter/receiver 27.

The user position detector 220 generates relative position information of the user terminal 20 (user P) for the beacon 12 or the payment processing device 30 that has transmitted the beacon signal based on the beacon signal acquired by the first beacon controller 210. When a plurality of beacon signals have been received, the user position detector 220 generates relative position information based on the plurality of beacon signals.

In this case, the user position detector 220 may generate relative position information for each acquired beacon signal and generate relative position information of the user terminal 20 by performing an arithmetic process on the relative position information, or may generate relative position information of the user terminal 20 using a plurality of beacon signals in the arithmetic process. The user position detector 220 may detect its own position measured by the position detector 26 as the position of the user terminal 20 (user P) and generate relative position information based on a position of its own device measured by the position detector 26.

The transmitter/receiver 230 receives various types of information, such as user-targeted provision information including auxiliary information and advertising information transmitted by the information processing device 100 and the like, via the communication interface 23. The transmitter/receiver 230 transmits entry information and exit information when the user P has entered and exited the commercial facility M, user information stored in the main storage device 22 and the like as well as the relative position information generated by the user position detector 220 to the information processing device 100 and the like via the communication interface 23.

The output controller 240 causes the input/output device 25 to display various types of information such as the relative position information generated by the user position detector 220 and the user-targeted provision information received by the transmitter/receiver 230. The output controller 240 may further cause a sound to be output from a speaker provided in the user terminal 20 or may cause a vibrator provided in the user terminal 20 to vibrate.

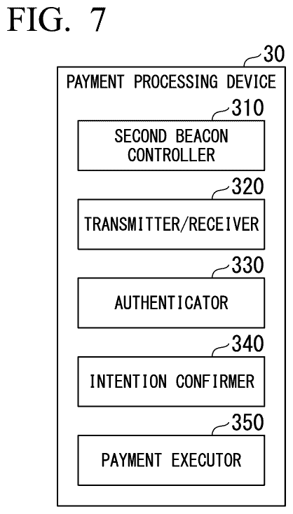

Next, a functional configuration of the payment processing device 30 will be described. FIG. 7 is a diagram showing an example including a functional configuration of the payment processing device 30 according to the first embodiment. The payment processing device 30 includes, for example, a second beacon controller 310, a transmitter/receiver 320, an authenticator 330, an intention confirmer 340, and a payment executor 350.

For example, functions of the payment processing device 30 are primarily executed by the housing unit 50 when the tablet 40 is stored in the holder 60 and executed by the tablet 40 when the tablet 40 is removed from the holder 60. When the tablet 40 is stored in the holder 60, the functions of the payment processing device 30 may be executed by the tablet 40 alone or may be executed by the tablet 40 and the housing unit 50 in cooperation.

The second beacon controller 310, for example, causes the second beacon signal transmitter/receiver 43 or the third beacon signal transmitter/receiver 56 to transmit beacon signals at regular intervals. The second beacon controller 310 acquires the beacon signal transmitted by the first beacon signal transmitter/receiver 27 and received by the second beacon signal transmitter/receiver 43 or the third beacon signal transmitter/receiver 56. The second beacon controller 310 generates relative position information of the user terminal 20 (user P) for the payment processing device 30 based on the acquired beacon signal.

The transmitter/receiver 320 receives various types of payment-related information transmitted by the user terminal 20, the information processing device 100, and the like via the communication interfaces 46 and 54. The transmitter/receiver 320 transmits various types of information including relative position information generated by the second beacon controller 310 and the like to the information processing device 100 and the like via the communication interfaces 46 and 54.

The authenticator 330 authenticates the user P who has purchased the product. The authenticator 330 authenticates the user P, for example, using information obtained by image processing of the user P's face imaged by the tablet camera 42. When authentication has succeeded, the authenticator 330 permits a payment by the payment unit 370. Facial authentication in the authenticator 330 is performed, for example, with reference to the user's facial information (or facial feature information) stored in the user terminal 20. The authenticator 330 may prevent the facial information used for authentication from being transmitted to an external device.

The intention confirmer 340 executes a process for confirming the user P's intention to purchase a product. The intention confirmer 340 confirms the user P's intention to purchase a product based on an intention-expressing behavior of the user P. To confirm the user P's intention, the intention confirmer 340 causes the touch panel 41 to display an image of the user P's face imaged by the tablet camera 42. The intention confirmer 340 affirms the user P's intention to purchase when the user P, for example, looks at the image of his or her own face displayed on the touch panel 41 for a certain period of time.

When the authentication by the authenticator 330 has succeeded, the payment executor 350 executes the payment for the product purchased by the user P. Moreover, the payment executor 350 may issue an electronic receipt after the payment for the product is completed. The payment executor 350 generates payment completion data on the condition that the payment is completed.

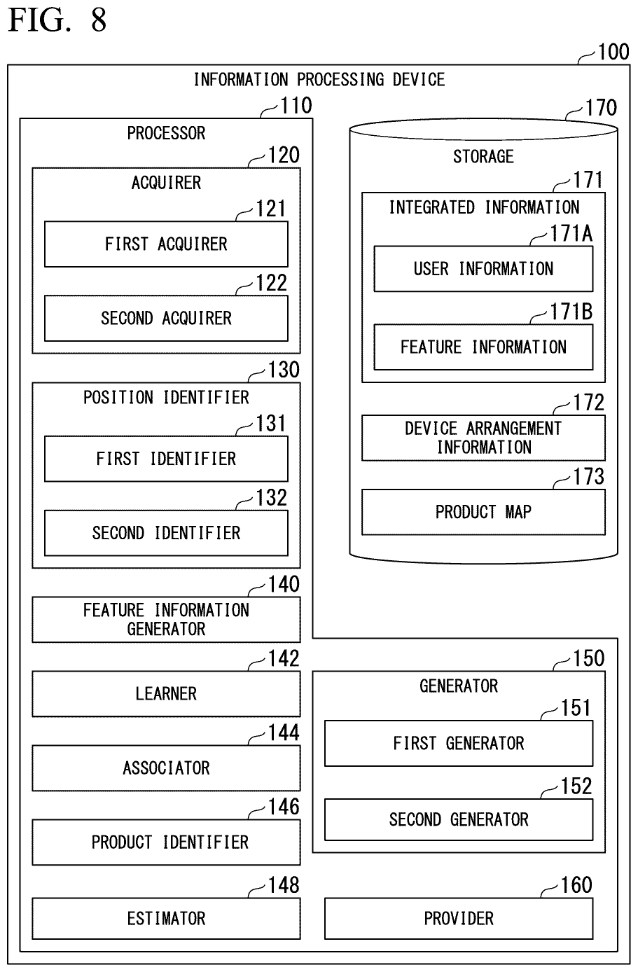

Next, a functional configuration of the information processing device 100 will be described. FIG. 8 is a diagram showing an example including the functional configuration of the information processing device 100 according to the first embodiment. The information processing device 100 includes, for example, a processor 110 and a storage 170. The processor 110 includes, for example, an acquirer 120, a position identifier 130, a feature information generator 140, a learner 142, an associator 144, a product identifier 146, an estimator 148, a generator 150, and a provider 160.

The storage 170 stores, for example, integrated user information (hereinafter, integrated information) 171, device arrangement information 172, and a product map 173. The integrated information 171 includes user information 171A and user feature information (hereinafter, feature information) 171B. The user information 171A is transmitted, for example, by the user terminal 20. The feature information 171B is acquired and generated by the feature information generator 140, for example, when the user P has entered the commercial facility M.

The integrated information 171 includes information about a user ID, the user P's age, and the user P's gender included in the user information 171A and the user P's clothing, hairstyle, height, or body shape information included in the feature information 171B. The feature information 171B may be at least one of the user P's clothing, hairstyle, height, and body shape information. The feature information 171B may include physical features of the user P such as a facial shape, an iris, fingerprints, a palm print, and an ear shape. These physical features, for example, may be information detected by a dedicated detection device.

The integrated information 171 is generated, for example, when the entry information is transmitted by the user terminal 20, and is maintained until the exit information is transmitted by the user terminal 20 having transmitted the entry information. The integrated information 171 is deleted after the exit information is received. The integrated information 171 may be stored in the storage 170 for a fixed period or indefinitely, without being deleted even after the exit information is received.

The device arrangement information 172 is information including absolute positions of the beacon 12 and the payment processing device 30 installed in the commercial facility M. The position of the beacon 12 is, for example, a position where the beacon is installed within the commercial facility M. The position of the payment processing device 30 is, for example, a position of the housing 50A. The absolute position is represented, for example, in an absolute coordinate system, but may also be represented in a coordinate system set using a point in the commercial facility M as a reference.

The product map 173 is a map indicating display positions of products to be sold in the commercial facility M. The product map 173 also indicates a position of a weight sensor that detects the weight of the products together with the display positions of the products. The product map 173 is updated, for example, when the commercial facility M opens, in accordance with a product display status that day.

The acquirer 120 acquires various types of information transmitted by the in-shop camera 11, the beacon 12, the user terminal 20, and the payment processing device 30. The acquirer 120 acquires, for example, image information transmitted by the in-shop camera 11 and user information transmitted by the beacon 12.

The acquirer 120 includes, for example, a first acquirer 121 and a second acquirer 122. The first acquirer 121 acquires image information transmitted by the in-shop camera 11 and detects the user P based on image processing results. When the user P has been detected, the first acquirer 121 assigns a user detection ID to the detected user P.

The first acquirer 121 further analyzes the image and acquires behavior information by detecting the behavior of the detected user P. The behavior information is information used to calculate the first calculated position, and is specifically information based on image information including the user P. The behavior information is an example of first information about users of the commercial facility.

The behavior information includes, for example, facial orientation information, gaze time information, and putting-into-basket action information of the user P. The facial orientation information is information indicating a facial orientation of the user P. The gaze time information is information indicating the duration for which the user P continues to gaze. The putting-into-basket action information indicates that the user P is performing an action of putting products into the shopping basket M2.

The information processing device 100 may receive and acquire behavior information generated by a device other than the information processing device 100. For example, the behavior information may be generated by the user terminal 20 or the payment processing device 30, and the information processing device 100 may acquire the behavior information transmitted by the user terminal 20 or the payment processing device 30.

The second acquirer 122 acquires user information transmitted by the user terminal 20 as second information about the user P different from the first information. For example, the user information is transmitted by the user terminal 20 together with entry information when the user P enters the commercial facility M. The second acquirer 122 further acquires, as the second information, relative position information generated based on the beacon signal transmitted by the beacon 12. The second acquirer 122 generates the integrated information 171 including the acquired user information 171A and stores the integrated information 171 in the storage 170.

The position identifier 130 includes, for example, a first identifier 131 and a second identifier 132. For example, when the user P is detected by the first acquirer 121, the first identifier 131 calculates the position of the user P based on image information transmitted by the in-shop camera 11 and identifies the position as the first calculated position. Because the position of the in-shop camera 11 is an absolute position, the first calculated position becomes an absolute position.

The second identifier 132 calculates the relative position of the user P as the second calculated position based on the relative position information transmitted by the beacon 12 or the user terminal 20 and information of the absolute position of the beacon 12 included in the device arrangement information 172. The second identifier 132 identifies the absolute position of the user P based on the calculated relative position of the user P and the absolute position of the beacon 12 or the user terminal 20 included in the device arrangement information 172.

The first calculated position is a position calculated using image processing, and the second calculated position is a position calculated using relative position information. A computational load required to calculate the second calculated position is smaller than a computational load required to calculate the first calculated position. The second calculated position is a position that is identified with a smaller computational load than the first calculated position.

The feature information generator 140 extracts a feature of the user P based on image information obtained by imaging the user P at the time of entry. The feature information generator 140 generates feature information 171B of the user P based on, for example, the extracted feature of the user P. The feature information generator 140 combines the generated feature information 171B with user information 171A acquired by the second acquirer 122 to generate the integrated information 171. The feature information generator 140 stores the generated integrated information 171 in the storage 170.

The learner 142 updates a trained model for identifying a user based on the image information acquired by the first acquirer 121. The trained model is trained by machine learning using an image of the user as input data and a likelihood of the user as output data. When image information including the user P is newly acquired by the first acquirer 121, the learner 142 updates the trained model using the acquired image information as input data.

The interior of the commercial facility M is entirely divided into a video analysis area where a user detection ID is associated with a user ID and a non-analysis area where the user detection ID is not associated with the user ID. When the user P who has entered the commercial facility M is in the non-analysis area, the first identifier 131 does not perform image processing, and the second identifier 132 identifies the second calculated position of the user P. When the second calculated position of the user P identified by the second identifier 132 moves from the non-analysis area to the video analysis area, the first identifier 131 performs image processing to calculate the first calculated position and detect the behavior of the user P.

The associator 144 associates the user ID included in the user information 171A included in the second information of the user P acquired by the second acquirer 122 with the user detection ID of the user P acquired by the first acquirer 121 based on the first calculated position of the user P identified by the first identifier 131 and the second calculated position of the user P identified by the second identifier 132. For example, when the first calculated position and the second calculated position match or a distance therebetween is within a predetermined threshold, the associator 144 associates the user ID transmitted by the user terminal 20 with the user detection ID. The user to whom the user detection ID is assigned is detected for each piece of image information transmitted by the in-shop camera 11.

The associator 144 associates the user ID transmitted by the user terminal 20, which is the second detection device, with the first information, such as behavior information based on image information obtained in an imaging process of the in-shop camera 11, which is the first detection device, by associating the user ID with the user detection ID. The first information may be, for example, information generated by processing information transmitted by the first detection device, such as image information about an image captured by the in-shop camera 11, or may be the information transmitted by the first detection device itself. For example, when the first detection device is a UWB device and the first information is a timestamp, the associator 144 associates the user ID transmitted by the user terminal 20 with the timestamp transmitted by the UWB device.

For example, when a plurality of users are detected by the first acquirer 121, the associator 144 may be unable to identify which user's user detection ID and user ID should be associated based only on the first calculated position and the second calculated position information. In this case, the associator 144 associates the user detection ID with the user ID based on the feature information 171B.

For example, when there are a plurality of users with common feature information between distances of the first calculated position and the second calculated position where the user ID is associated with the user detection ID, it is difficult to associate the user detection ID with the user ID. In this way, when the user ID cannot be associated with the user detection ID using only information about the first calculated position and the second calculated position, the associator 144 preferably associates the user ID with the user detection ID using the feature information 171B and the trained model.

Moreover, the associator 144 associates the user information with user-targeted provision information such as target-of-interest information estimated based on the behavior information and advertising information and product information included in the target-of-interest information. For example, the associator 144 creates a list of the target-of-interest information associated with the user information and stores the list in the storage 170. The listed target-of-interest information may be used, for example, even if advertisements to be provided to the user are created, and may also be used, for example, when advertising information for the user in the future is generated or the like.

For example, when a plurality of images of a user (hereinafter referred to as user images) are acquired by the first acquirer 121 as image information, the associator 144 extracts a feature of the user from the plurality of user images. The associator 144 compares the extracted feature with the feature of the first user P1 included in the user information 171A of the integrated information 171, and identifies the image of the user with a matching or similar feature as a user image obtained by imaging the first user P1. When the user image cannot be identified in the comparison with the user information 171A, the user image is identified in the comparison with the feature information 171B. The associator 144 associates the user ID with the user detection ID of the identified user image.

When the user ID is not associated with the user detection ID even in comparison with the feature information 171B, the associator 144 further associates the user ID with the user detection ID based on the image of the user obtained by image processing of the image information in the first acquirer 121 and the trained model stored in the storage 170.

For example, the associator 144 inputs a plurality of user images as input data to the trained model, and the trained model outputs output data for each of a plurality of input data items. The associator 144 identifies a user image obtained by imaging the first user P1 based on the output data output from the trained model. The associator 144 associates the user ID with the user detection ID of the identified user image.

When the first identifier 131 identifies putting-into-basket action information as behavior information, the product identifier 146 identifies a purchase target product for the user P based on the putting-into-basket action information. When a product put into the shopping basket M2 has been detected in the image processing in the first identifier 131, the product identifier 146 identifies the detected product as the purchase target product.

When the first identifier 131 has not identified a product put into the shopping basket M2, the product identifier 146 identifies the purchase target product based on weight information detected by a weight sensor installed on the display shelf M3. For example, when the first identifier 131 has detected an action in which the user P has picked up a product before the putting-into-basket action, the product identifier 146 identifies a product displayed in a position where its weight applied to the display shelf M3 among the plurality of products displayed on the display shelf M3 has become lighter as the purchase target product.

The estimator 148 estimates target-of-interest information about the target of interest of the user P based on the user information 171A of the user P acquired by the first acquirer 121 and the behavior information of the user P acquired by the first acquirer 121. For example, if the behavior of the user P acquired by the first acquirer 121 is the behavior of gazing at a certain product sold in the commercial facility M, when the gazing time exceeds a certain period of time, the estimator 148 estimates that the user P has a high interest in a product being viewed. For example, the estimator 148 estimates that the user P has a high interest in a product placed in the shopping basket M2.

The generator 150 includes, for example, a first generator 151 and a second generator 152. The first generator 151 generates user-targeted provision information about information to be provided to the user P based on the target-of-interest information estimated by the estimator 148. The first generator 151 generates, for example, product information about a product estimated to have a high interest of the user P, for example, information about the product lineup of a size, a color, a shape difference, and the like of a product, a function, a usage method, and the like as the user-targeted provision information.

In addition to the product information, the user-targeted provision information may include, for example, auxiliary information for assisting in the purchase of a product or advertising information about product advertisements. The auxiliary information may include, for example, product coupons, product inventory, related product information for a product, and ancillary information related to services associated with the product. The first generator 151 transmits information for displaying the generated auxiliary information and advertising information on the user terminal 20 of the user P to the user terminal 20 or displays the generated auxiliary information and advertising information on an in-facility display device, for example, digital signage, installed in the commercial facility M and located near the user P. The digital signage is an example of signage.

The second generator 152 generates employee-targeted provision information to be provided to employees of the commercial facility M based on the target-of-interest information estimated by the estimator 148. The employee-targeted provision information includes, for example, at least one of the user information 171A of the user P, the position information indicating the position of the user P, and the target-of-interest information.

The user information 171A included in the employee-targeted provision information may use a part or all of the user information 171A included in the integrated information 171 stored in the storage 170 as it is. The second generator 152 may also include the feature information 171B included in the integrated information 171 in the employee-targeted provision information. The position information indicating a position of the user P may indicate, for example, either the first calculated position or the second calculated position, or may indicate a position calculated based on the first calculated position and the second calculated position, for example, an intermediate position between the first calculated position and the second calculated position.

The second generator 152 provides the generated employee-targeted provision information to employees of the commercial facility M. The employee having received the employee-targeted provision information, for example, identifies the user P who are interested in a product and moves near the user P, or prepares to explain to the user P information about the product that user P is interested in, such as the product's quality and usage method.

The provider 160 provides provision information generated by the generator 150 by transmitting the provision information to various types of external devices. For example, the provider 160 provides the user-targeted provision information generated by the first generator 151 to the user terminal 20 or the digital signage at the commercial facility M. For example, the provider 160 transmits the employee-targeted provision information generated by the second generator 152 to an employee terminal carried by an employee of the commercial facility M.

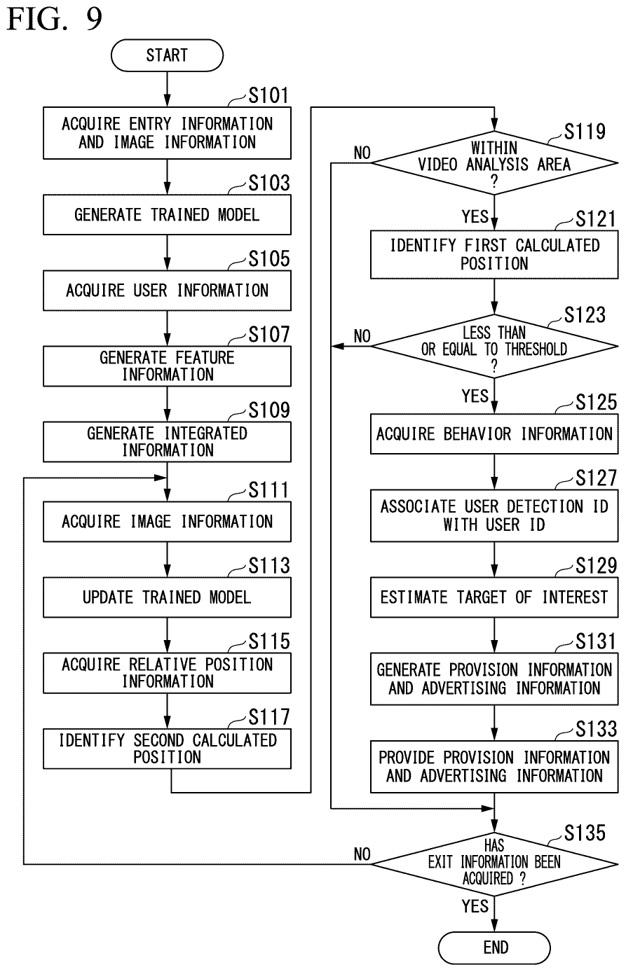

Next, a process of the information processing device 100 will be described. FIG. 9 is a flowchart showing an example of the process of the information processing device 100 according to the first embodiment. In the flowchart shown in FIG. 9, the process of the information processing device 100 from the time when the user P enters the commercial facility M to the time when the user P exits the commercial facility M will be described.

When the user P enters the commercial facility M through the entrance gate M1, the user terminal 20 carried by the user P uses a beacon signal to transmit the entry information and the user information 171A to the information processing device 100 via the beacon 12. The in-shop camera 11 installed at the entrance gate M1 captures an image of the user P passing through the entrance gate M1.

The in-shop camera 11 transmits image information about an image including the user P to the information processing device 100. The information processing device 100 generates and acquires the entry information transmitted by the beacon 12 using the first acquirer 121, and also acquires the image information transmitted by the in-shop camera 11 using the first acquirer 121 (step S101).

Subsequently, the learner 142 extracts an image of the user P included in the image information acquired by the first acquirer 121 and generates a trained model using the image of the user P as input data and the likelihood of the user P as output data (step S103). The learner 142 stores the created trained model in the storage 170. The learner 142 may assign a user ID to the trained model and hold the user ID stored in the storage 170 without deleting the user ID from the storage 170 even after the user P exits the commercial facility M, so that the user ID can be used when the user P re-enters the commercial facility M.

Subsequently, the second acquirer 122 acquires the user information 171A transmitted by the beacon 12 (step S105). The feature information generator 140 extracts a feature of the user P based on image information acquired by the acquirer 120. The feature information generator 140 generates feature information about the user P, for example, based on the extracted feature of the user P (step S107).

Subsequently, the feature information generator 140 generates integrated information 171 (step S109). The feature information generator 140 combines the generated feature information with the user information 171A acquired by the second acquirer 122 to generate the integrated information 171 including the user information 171A and the feature information 171B, and stores the integrated information 171 in the storage 170.

Subsequently, the user P enters the commercial facility M. A plurality of in-shop cameras 11 are installed in the commercial facility M. These in-shop cameras 11 image the inside of the commercial facility M at any time and transmit image information about the captured images to the information processing device 100. The information processing device 100 acquires the image information transmitted by the in-shop cameras 11 each time using the acquirer 120 (step S111). The acquirer 120 stores the acquired image information in the storage 170.

Subsequently, the learner 142 reads the trained model stored in the storage 170 and updates the trained model using the image information acquired by the acquirer 120 as input data (step S113). The learner 142 stores the updated trained model in the storage 170. One or both of the process for acquiring the image information in step S111 and the process for updating the trained model in step S113 may be omitted and the number of times (frequency) of execution thereof may be reduced to reduce an amount of processing.

Subsequently, the second acquirer 122 acquires the relative position information transmitted by the beacon 12 (step S115). Subsequently, the second acquirer 122 acquires an absolute position of the beacon 12 having transmitted the relative position information with reference to the device arrangement information 172 stored in the storage 170.

Subsequently, the second identifier 132 calculates and identifies a second calculated position of the user P based on the relative position transmitted by the beacon 12 and the absolute position of the beacon 12 having transmitted the relative position information (step S117). Subsequently, the second identifier 132 determines whether or not the second calculated position of the user P is included in the video analysis area (step S119).

When the second identifier 132 determines that the second calculated position of the user P is included in the video analysis area, the first identifier 131 analyzes the image of the user P after the image is captured by the in-shop camera 11 and calculates the user P's relative position for the in-shop camera 11. Subsequently, the first identifier 131 acquires the absolute position of the in-shop camera 11 having captured the image from which the user P's relative position has been calculated with reference to the device arrangement information 172 stored in the storage 170.

Subsequently, the first identifier 131 calculates and identifies the user P's absolute position based on the relative position of the user P for the in-shop camera 11 obtained by analyzing the image and the absolute position of the in-shop camera 11 having captured the image from which the user P's relative position has been calculated (step S121). Subsequently, the associator 144 calculates a distance between the first calculated position and the second calculated position and determines whether or not the distance between the first calculated position and the second calculated position is less than or equal to a threshold (step S123).

When the first identifier 131 determines that the distance between the first calculated position and the second calculated position is less than or equal to the threshold, the first acquirer 121 detects the user P's behavior based on a result of image processing of the image information transmitted by the in-shop camera 11, thereby acquiring facial orientation information, gaze time information, and putting-into-basket action information of the user P as behavior information (step S125).

Subsequently, the associator 144 associates the user detection ID acquired by the first acquirer 121 with the user ID included in the user information 171A transmitted by the beacon 12 and stored in the storage 170 (step S127). Information (list information) indicating that the user detection ID and the user ID are associated is stored in the storage 170. The associator 144 may associate the user ID with the user detection ID when the distance between the first calculated position and the second calculated position is less than or equal to the threshold.

Subsequently, the estimator 148 estimates the user's target of interest (step S129). For example, the estimator 148 identifies a target of interest, such as a product, that the user P is gazing at, based on facial orientation information of the user P included in the behavior information. The estimator 148 calculates a period of time during which the user P gazes at the target of interest based on gaze time information included in the behavior information. When the gaze duration for the target of interest exceeds a threshold, the estimator 148 estimates the identified target of interest as the user's target of interest.

When the estimator 148 estimates the user's target of interest, the product identifier 146 identifies the purchase target product for the user P when putting-into-basket action information is identified as the behavior information and the product put into the shopping basket M2 is detected. The product identifier 146 may identify the purchase target product based on the product map 173 stored in the storage 170 and weight information measured by the weight sensor installed on the display shelf M3. The product identifier 146 may identify the purchase target product by appropriately combining the above-described information items. The estimator 148 estimates the identified purchase target product as the target of interest of the user P.

Subsequently, the generator 150 generates provision information and advertising information (step S131). The provision information includes user-targeted provision information to be provided to the user P generated by the first generator 151 and employee-targeted provision information to be provided to employees of the commercial facility M generated by the second generator 152. The advertising information is generated by the first generator 151. The associator 144 associates the user information with the target-of-interest information estimated by the estimator 148 and the provision information and the advertising information generated by the generator 150 to create a list, and stores the list in the storage 170 as list information. When the list information has already been generated in the storage 170, the associator 144 updates the stored list information.

Subsequently, the provider 160 transmits and provides the provision information generated by the generator 150 to various types of external devices (step S133). The provider 160, for example, transmits and provides the user-targeted provision information including product information, auxiliary information, advertising information generated by the first generator 151 and the like to the user terminal 20.

The provider 160, for example, transmits and provides the employee-targeted provision information generated by the second generator 152 to the employee terminal. The provider 160 may transmit and provide the employee-targeted provision information to employee terminals of all employees in the commercial facility M, or may transmit and provide the employee-targeted provision information to one or more employees in the vicinity of the user P.

Subsequently, the acquirer 120 determines whether or not the exit information transmitted by the user terminal 20 has been acquired (step S135). Moreover, even if the second identifier 132 determines that the second calculated position of the user P is not included in the video analysis area in step S119, the acquirer 120 determines whether or not the exit information transmitted by the user terminal 20 has been acquired (step S135).

When it is determined that the exit information transmitted by the user terminal 20 has been acquired, the acquirer 120 returns the process to step S111 and acquires image information. When it is determined that the exit information transmitted by the user terminal 20 has not been acquired by the acquirer 120, the information processing device 100 ends the process shown in FIG. 9.

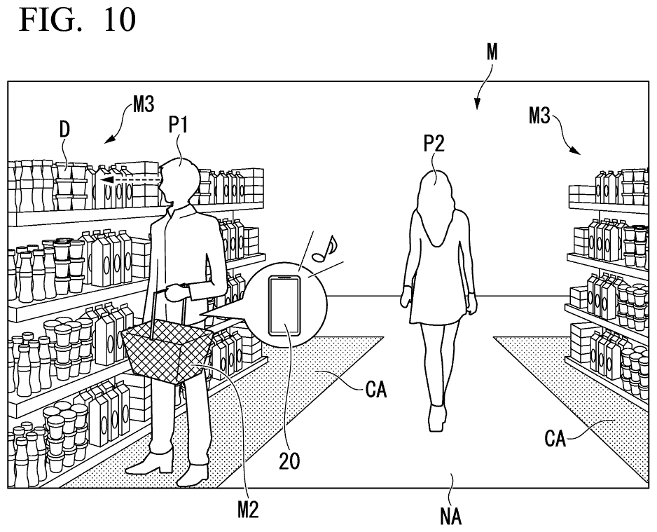

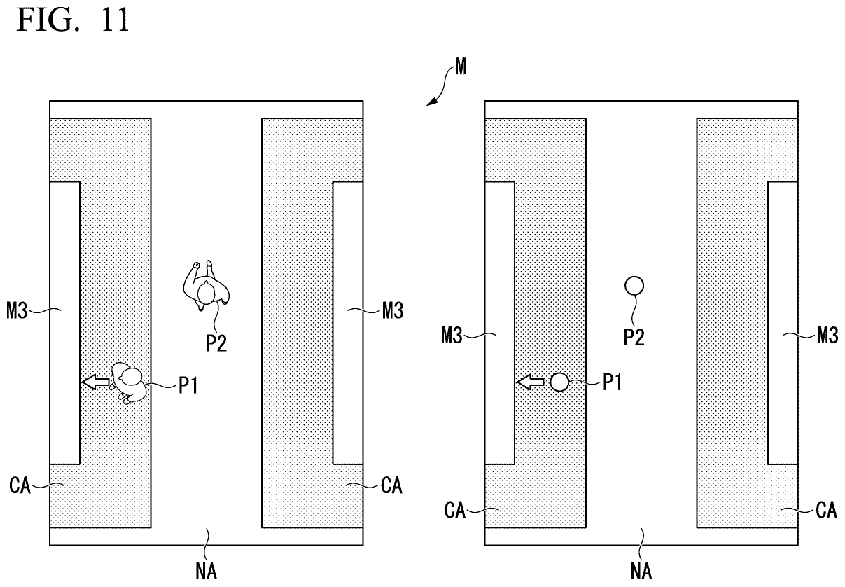

Next, an example of a situation within the commercial facility M when the process is executed by the information processing device 100 will be described. FIG. 10 is a perspective view showing the example of the situation within the commercial facility. FIG. 11 is a view of an example of the situation within the commercial facility viewed from above. FIGS. 10 and 11 show current positions of a first user P1 and a second user P2 in a corner of the commercial facility M.

The left drawing in FIG. 11 shows, for example, an image obtained by image analysis of an image captured by the in-shop camera 11. The right drawing in FIG. 11 shows an image of a map of a corner of the commercial facility M in which the first user P1 and the second user P2 are plotted at positions based on relative position information transmitted by the beacon 12 or the user terminal 20. The current positions of the first user P1 and the second user P2 shown in the left drawing in FIG. 11 correspond to first calculated positions, while the current positions of the first user P1 and the second user P2 shown in the right drawing in FIG. 11 correspond to second calculated positions.

In the states shown in FIGS. 10 and 11, the first user P1 is carrying the user terminal 20 and is standing in front of the display shelf M3 with the shopping basket M2 while shopping. The first user P1 is gazing at a product D on the display shelf M3. The current position of the first user P1 is located within a video analysis area CA. Like the first user P1, the second user P2 is carrying the user terminal 20 and walking down the aisle between two display shelves M3. The current position of the second user P2 is within a non-analysis area NA.

After the first user P1 enters the commercial facility M, the beacon 12 and the user terminal 20 carried by the first user P1 transmit and receive beacon signals therebetween. As a result of the transmission and reception of the beacon signals, one or both of the beacon 12 and the user terminal 20 carried by the first user P1 generate relative position information and transmit the relative position information to the information processing device 100.

After the beacon 12 or the second user P2 enters the commercial facility M, the user terminal 20 carried by the second user P2 generates relative position information and transmits the relative position information to the information processing device 100, like the user terminal 20 of the first user P1. The information processing device 100 calculates second calculated positions of the first user P1 and the second user P2 within the commercial facility M based on the transmitted relative position information.

In the states shown in FIGS. 10 and 11, the second identifier 132 of the information processing device 100 detects that the first user P1 is included in the video analysis area CA. In this case, the first acquirer 121 analyzes the image of the first user P1 captured by the in-shop camera 11 to detect the first user P1. When the first acquirer 121 detects the first user P1, a user detection ID is assigned thereto.

The first identifier 131 identifies the first calculated position of the first user P1. On the other hand, because the second user P2 is included in the non-analysis area NA, the first acquirer 121 cannot detect the second user P2, and the first identifier 131 does not identify the first calculated position of the second user P2.

Subsequently, the associator 144 associates the user ID with the user detection ID based on a result of comparing the first calculated position and the second calculated position. After the user ID is associated with the user detection ID, for example, information about the first user P1 acquired by the first acquirer 121 is used as information about the first user P1 whose current position is the second calculated position.

For example, the first acquirer 121 uses behavior information of the first user P1 detected based on image information as behavior information of the first user P1 whose current position is the second calculated position. For example, after the user ID is associated with the user detection ID, information about an action of putting a product into the shopping basket M2, a facial orientation of the first user P1, and the duration of gaze is acquired as the behavior information of the first user P1. Although the behavior information is detected based on image information, and its acquisition requires a large amount of computational processing, the information processing device 100 acquires the behavior information after the user ID is associated with the user detection ID. Therefore, it is possible to reduce the amount of computational processing in the information processing device 100.

Moreover, the information processing device 100 uses the estimator 148 to generate target-of-interest information indicating, for example, that the first user P1 has a high interest in a product that he or she gazes at or has put into the shopping basket M2. The first generator 151, for example, generates product-related information, such as discount coupons for products as a target of interest, based on the target-of-interest information, and the provider 160 transmits the generated product-related information to the user terminal 20 of the first user P1. Therefore, for example, by providing coupon information or advertising information to the first user P1 who is gazing at a product and wondering whether or not to purchase it, it is possible to encourage the first user P1 to purchase the product.

Moreover, the provider 160 may, for example, transmit and provide the advertising information generated by the first generator 151 to digital signage in the commercial facility M located near the user P. For example, the provider 160 may transmit and provide the advertising information to the digital signage when the second calculated position of the first user P1 approaches the vicinity of the digital signage.

Moreover, in the information processing device 100, after the estimator 148 generates target-of-interest information, it is assumed that the second generator 152 generates, for example, employee-targeted provision information indicating that the first user P1 is gazing at a product for a long time and is standing in front of the display shelf M3. In this case, the provider 160 provides the generated employee-targeted provision information to an employee of the commercial facility M, thereby providing the employee of the commercial facility M with information about the presence and current position of the first user P1, who is unsure about a product purchase or seeking product explanations. Therefore, the employee can easily support the first user P1 in purchasing a product.

Moreover, when there are a plurality of users around the first user P1, the image in the image information will include a plurality of users including the first user P1. In this case, because the first identifier 131 identifies first calculated positions of a plurality of users, a situation in which the associator 144 cannot determine which first calculated position is the first calculated position of the first user P1 is conceived.

In this case, the associator 144 decides the user ID serving as a target to be associated with the user detection ID based on the feature information generated by the feature information generator 140. For example, when the first user P1 has a feature of a tall person with long hair and wearing a red jacket, the associator 144 extracts a tall person with long hair and wearing a red jacket based on the image information.

The associator 144 associates the user ID with the user detection ID using the extracted person as the first user. In this way, the information processing device 100 can identify the first user P1 with high accuracy even if there are a plurality of users in the vicinity of the first user P1 using feature information.

Furthermore, when a plurality of users including the first user P1 are included in the image in the image information, the feature information generated by the feature information generator 140 may be common. In this case, a situation in which the associator 144 cannot determine which first calculated position is the first calculated position of the first user P1 is conceived.

In this case, the associator 144 reads the trained model stored in the storage 170, inputs images of a plurality of users as input data to the trained model, and causes the trained model to output output data. Based on the output data output by the trained model, the associator 144 associates the user ID with the user detection ID of the image of the user who is most likely to be the first user P1. In this way, by using the trained model, the information processing device 100 can identify the first user P1 with high accuracy even if there are a plurality of users in the vicinity of the first user P1.

For example, in the information processing system 1, in the above-described first embodiment in which the plurality of in-shop cameras 11 and the beacons 12 are installed within the commercial facility M, the position of the user P within the commercial facility M is tracked all the time based on relative position information transmitted by the beacons 12 and the user terminal 20. During a situation in which detailed information about the user P, for example, behavior information, is desired to be obtained, the user's behavior information is acquired based on image information transmitted by the in-shop cameras 11. This control significantly reduces the computational load on the information processing device 100.

The functions of each device in the above-described first embodiment may be provided by other devices. For example, the payment processing device 30 may provide some or all of the functions of the information processing device 100. Although an example in which user information 171A is associated with first information when the user P shops within a commercial facility in the above-described first embodiment has been described, the association can also be performed in situations other than shopping.

For example, when the user P is an elderly person and an abnormal situation of the user P, for example, a fall, is detected based on the image information, the user information 171A may be associated with the first information of the user P so that the user P can be identified. Alternatively, when the user P is a child and becomes lost within the commercial facility P or the like, the user information 171A may be associated with the user P's first information so that the user P can be identified.

In the above-described first embodiment, the associator 144 associates the user ID included in the user information 171A with the user detection ID assigned to the user detected by image processing in the acquirer 120. Alternatively, the associator 144 may directly associate the user ID included in the second information with the user detected by image processing without assigning the user detection ID thereto. The associator 144 may further directly associate the user ID included in the second information with behavior information of the user detected by image processing, advertising information and product information generated based on the behavior information, and the like.

Although the information processing device 100 associates information within the commercial facility M in the above-described first embodiment, the information processing device 100 may also associate information about users within facilities other than the commercial facility M. The information processing device 100 may also associate information about users outdoors.

Although the first detection device is the in-shop camera 11 and the second detection device is a combination of the beacon 12 and the user terminal 20 in the above-described first embodiment, the combination of the first detection device and the second detection device may also be a combination of other detection devices capable of acquiring information for identifying the user's position.

For example, the first detection device may be a detection device using a scheme of UWB, Wi-Fi, ETC, GPS, or the like in addition to an in-shop camera, and may be a detection device different from the second detection device. The first information associated with the user information 171A may be information other than behavior information, and may be, for example, timestamp information. In these cases, both the first calculated position and the second calculated position may be absolute positions, or one may be an absolute position and the other may be an absolute position calculated based on a relative position.

Moreover, while the advertising information generated in the first embodiment is generated based on information acquired while the user P is in the shop, the advertising information may also be generated based on other information. For example, the advertising information may be generated using position information or time information acquired when the user P previously visited the shop or when the user P visited another shop.

Moreover, various types of information acquired or generated by the information processing device 100 (user information, behavior information, position information, and the like) may be stored in the storage 170 and used for marketing analysis as batch processing. Moreover, the information processing device 100 may acquire date and time information, purchase information, weather information, and the like from the Internet or an external system to perform more advanced marketing analysis.

### Second Embodiment

Next, a second embodiment will be described. In the following description, constituent elements and functions identical to the first embodiment are denoted by the same reference signs, and their description may be omitted.

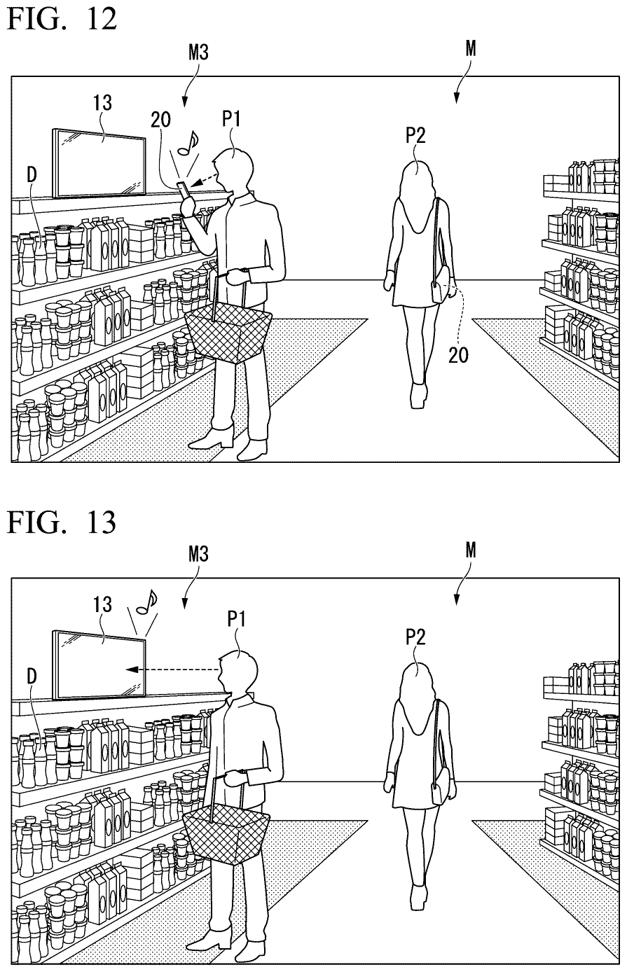

In the second embodiment, digital signage is installed, for example, on a display shelf. FIG. 12 is a perspective view showing an example of a situation within a commercial facility according to the second embodiment. In the second embodiment, a display device 13 is installed on a display shelf M3 along with a product D. The display device 13 includes, for example, a display and a speaker. Each of a first user P1 and a second user P2 carries a user terminal 20. The first user P1 holds the user terminal 20 in his or her hand, while the second user P2 has the user terminal 20 in his or her bag.

The first generator 151 in the information processing device 100 shown in FIG. 8 generates advertising information about advertisements to be displayed on an input/output device 25 (FIG. 3) consisting of a display device 13 or a touch panel display of the user terminal 20. A provider 160 causes the display device 13 or the input/output device 25 to display an advertisement based on the generated advertising information.

When an advertisement based on the generated advertising information is displayed on the display device 13 or the input/output device 25, the provider 160 may output a sound from a speaker or may output a sound from the speaker without displaying the advertisement. The first generator 151 may generate information about the advertisement, for example, information indicating a genre of the advertisement, and provide the generated information about the advertisement to the display device 13 or the user terminal 20. In this case, the specific advertisement may be decided by the display device 13 or the user terminal 20.

The first acquirer 121, for example, acquires behavior information of the first user P1 and the second user P2 imaged by the in-shop camera 11. Based on the acquired behavior information, the first acquirer 121 determines the intentions of the first user P1 and the second user P2 to view an advertising display medium, for example, whether or not they are gazing at the display device 13 or the user terminal 20.

In this example, the first user P1 is gazing at the display device 13 or the user terminal 20, while the second user P2 is gazing at neither the display device 13 nor the user terminal 20. The first acquirer 121 determines that the first user P1 is gazing at the display device 13 as an advertisement display medium and has an intention to view the display device 13.

The viewing intention confirmed by the first acquirer 121 may be determined to be a process in which the user is intending to view the advertisement display medium, in place of or in addition to a process in which the user views the advertisement display medium. In this case, the first acquirer 121 may determine whether or not the user is intending to view the display device 13 based on, for example, changes in the user's line of sight and head movement, the user's preferences, and the like.

The first generator 151, for example, generates advertising information for displaying an advertisement suitable for the first user P1 on the input/output device 25 of the user terminal 20 when the first acquirer 121 determines that the first user P1 is gazing at the user terminal 20. The first generator 151, for example, decides content of the advertisement suitable for the first user P1 based on the behavior estimated by the estimator 148 or information according to the user ID associated with the user detection ID by the associator 144.

FIG. 13 is a perspective view showing another example of a situation within a commercial facility according to the second embodiment. For example, when the first acquirer 121 determines that the first user P1 is gazing at the display device 13, the first generator 151 generates advertising information for displaying an advertisement suitable for the first user P1 on the input/output device 25 of the user terminal 20 carried by the first user P1.

The provider 160 selects a display device for displaying an advertisement based on the generated advertising information, from a plurality of display devices, here, the display device 13 and the input/output device 25, based on the viewing intention of the first user P1 acquired by the first acquirer 121. For example, the provider 160 selects a device that the first user P1 intends to view as a display on which the advertisement is displayed from the display device 13 and the input/output device 25.

The information processing device 100 according to the second embodiment has functions and effects similar to those of the first embodiment. For example, because the associator 144 associates the user detection ID with the user ID, it is possible to decide the content of the advertisement based on information obtained from the user ID. Thereby, it is possible to perform efficient advertising. Furthermore, the information processing device 100 according to the second embodiment causes the display device selected by the provider 160 as the display device the user is viewing or intending to view, for example, the display device 13 or the input/output device 25 of the user terminal 20, to display the advertisement. Thereby, it is possible to perform more efficient advertising.

Although the content of the advertisement is decided based on the user ID in the second embodiment, the content of the advertisement may also be decided based on another element. The first generator 151, for example, may decide the content of the advertisement based on information about items displayed on the display shelf M3 on which the display device 13 is installed, whether or not the first user P1 has picked up a product D, whether or not the first user P1 has put back the product D that he or she picked up, and the like.

Although an advertisement is displayed on the display device 13 or the input/output device 25 of the user terminal 20 in the second embodiment, the information processing device 100 may transmit a coupon for a discount on a product D to the user terminal 20 and provide the coupon to the user in place of or in addition to the display of advertisement. The coupon provided here may be, for example, a coupon related to the product D that the user picked up, a coupon related to the product D that the user was about to pick up, coupons related to these products D, or the like.

Furthermore, the information processing device 100 may include an effect measurer that measures the effect of an advertisement displayed on the display device 13 or the input/output device 25 of the user terminal 20. The effect measurer, for example, may acquire and aggregate information on whether or not the user has viewed an advertisement. The determination of whether or not the user has viewed an advertisement, for example, may be performed based on behavior information of the user. The effect measurer may measure the presence or absence and degree of effect of the advertisement based on the aggregated information. The effect measurer may further acquire and aggregate information such as whether or not an advertised product has been purchased.

### Third Embodiment

Next, a third embodiment will be described. In the third embodiment, for example, digital signage and a speaker are installed inside an elevator that transports customers, installed in a commercial facility. The elevator may also be installed in a building other than a commercial facility. Instead of the digital signage, another display device, such as a projector that projects an image onto the elevator door, may be installed. The elevator is an example of a customer transport device.

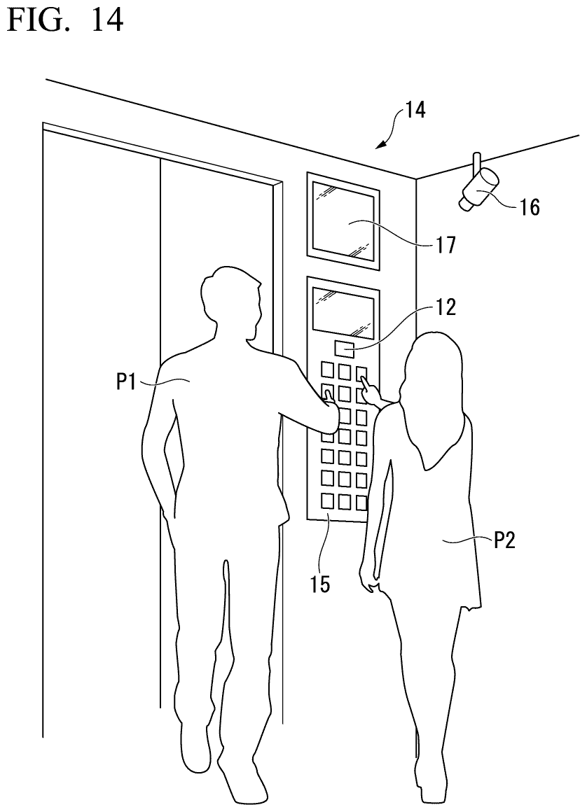

FIG. 14 is a perspective view showing an example of the interior of an elevator according to the third embodiment. In the third embodiment, an operation panel 15 is provided in an elevator 14. A beacon 12 is provided in the operation panel 15 as in the first embodiment. The operation panel 15 includes a plurality of destination floor buttons.

The operation panel 15 transmits destination floor information to an information processing device 100 according to an operated destination floor button. In the example shown in FIG. 14, for example, a first user P1 operates a destination floor button for designating a 5^{th} floor, and a second user P2 operates a destination floor button for designating a 14^{th} floor. The information processing device 100 acquires the transmitted destination floor information using a first acquirer 121. The first acquirer 121 may acquire the destination floor information about the destination floors of the first user P1 and the second user P2 by performing image analysis of image information transmitted by an in-elevator camera 16. The destination floor is an example of a user's movement destination. The destination floor information is an example of movement destination information.

The in-elevator camera 16 is provided on the ceiling of the elevator 14. The in-elevator camera 16 is provided in place of or in addition to the in-shop camera 11 in the first embodiment. The in-elevator camera 16 is arranged in a position where an image of the entire interior of the elevator 14 can be captured. The in-elevator camera 16 transmits image information about the captured images to the information processing device 100.

Digital signage 17 is installed above the operation panel 15. The first user P1 and the second user P2 enter the elevator 14. Both the first user P1 and the second user P2 possess user terminals 20. In the state shown in FIG. 14, both the first user P1 and the second user P2 have the user terminals 20 in their pockets or the like.

A first generator 151 in the information processing device 100 generates advertising information about advertisements to be displayed on the digital signage 17 or an input/output device 25 including a touch panel display of the user terminal 20. The provider 160 causes the digital signage 17 or the input/output device 25 to display advertisements based on the generated advertising information. When advertisements based on the generated advertising information are displayed on the digital signage 17 or the input/output device 25, the provider 160 may output a sound from a speaker or may output a sound from the speaker without displaying the advertisement.

The first acquirer 121 estimates behaviors of the first user P1 and the second user P2, for example, based on images captured by the in-elevator camera 16. Based on the estimated behaviors, the first acquirer 121 determines whether the first user P1 and the second user P2 have intended to view the digital signage 17 or the user terminal 20.

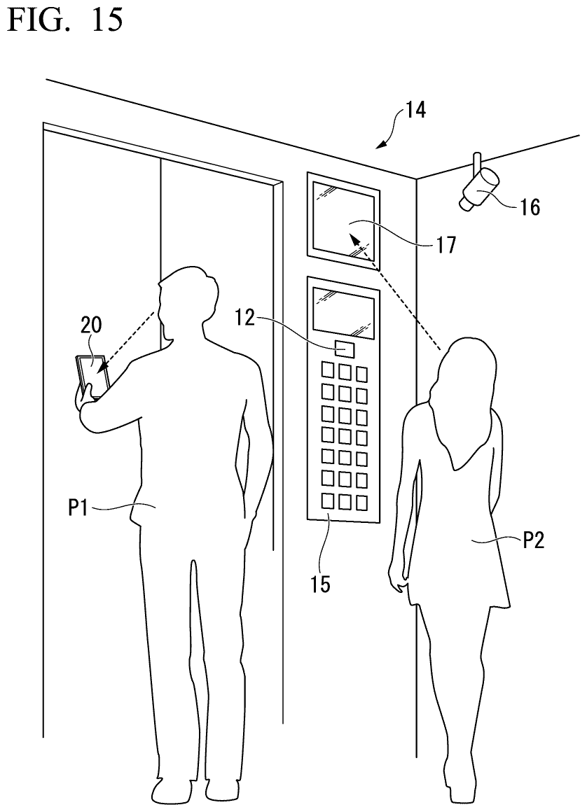

FIG. 15 is a perspective view showing another example of the interior of an elevator according to the third embodiment. FIG. 15 shows the interior of the elevator following FIG. 14. In the state shown in FIG. 15, it is determined that the first user P1 is gazing at the input/output device 25 of the user terminal 20, and the second user P2 is gazing at the digital signage 17. As in the second embodiment, the first acquirer 121 may determine whether or not the user has intended to view the user terminal 20 or the digital signage 17, in place of or in addition to determining whether the user is gazing at the user terminal 20 or the digital signage 17.

The associator 144 associates the user detection ID with the user ID, and also associates the user detection ID with the destination floor information acquired by the first acquirer 121. Using the user detection ID and the user ID that have already been associated, the associator 144 associates the user ID of the first user P1 with the destination floor information. Likewise, the associator 144 associates the second user P2 with the user ID and the destination floor information.

For example, when the first acquirer 121 determines that the first user P1 and the second user P2 are viewing the user terminal 20 or the digital signage 17, the first generator 151 generates advertising information for displaying advertisements suitable for the first user P1 and the second user P2. For example, the first generator 151 decides the content of the advertisements suitable for the first user P1 and the second user P2 based on the user information and destination floor information associated with the user IDs of the first user P1 and the second user P2.

The first generator 151 displays information about products to be sold in shops located on the destination floor of the first user P1, for example, based on the destination floor information. Furthermore, the first generator 151 generates advertising information about advertisements according to the user information of the first user P1, for example, advertisements for men's clothing when the first user P1 is an adult male. Advertising information is generated similarly for the second user P2.

The provider 160 selects a display device for displaying an advertisement based on the generated advertising information from a plurality of display devices, i.e., here, the user terminal 20 and the digital signage 17, based on the visual recognition intentions of the first user P1 and the second user P2 determined by the first acquirer 121. For example, when the first acquirer 121 determines that the first user P1 has an intention to view the user terminal 20, the provider 160 causes the user terminal 20 of the first user P1 to display an advertisement suitable for the first user P1. For example, when the first acquirer 121 determines that the second user P2 has an intention to view the digital signage 17, the provider 160 causes the digital signage 17 to display an advertisement suitable for the second user P2.

The information processing device 100 according to the third embodiment has functions and effects similar to those of the second embodiment. Furthermore, the information processing device 100 of the third embodiment acquires destination floor information about the user's destination floor and causes a display device that the user is viewing or has an intention to view, such as the user terminal 20 or the digital signage 17 within the elevator, to display an advertisement related to the destination floor. Therefore, it is possible to perform more efficient advertising. Furthermore, the information processing device 100 according to the third embodiment causes a display device selected by the provider 160 as a display device that a plurality of users are viewing or have an intention to view to display an advertisement. For example, when the first user P1 has an intention to view the display device 13 of the user terminal 20, the provider 160 selects the display device 13 of the user terminal 20 and causes the advertisement to be displayed. For example, when the second user P2 has an intention to view the digital signage 17, the provider 160 selects the digital signage 17 and causes an advertisement to be displayed thereon. Because these advertisement display processes can be controlled simultaneously in parallel, it is possible to perform more efficient advertising.

Although advertisements are displayed on the user terminal 20 and the digital signage 17 in the third embodiment, the information processing device 100 may also transmit a coupon for a discount on a product D to the user terminal 20 and provide the coupon to the user in place of or in addition to displaying an advertisement. The coupon provided here may be, for example, a coupon that can be used in a shop on the user's destination floor or the like.

Furthermore, the information processing device 100 may include an effect measurer that measures the effect of displaying an advertisement on the user terminal 20 or the digital signage 17. The effect measurer, for example, may acquire and aggregate information about whether or not the user has viewed the advertisement. Whether or not the user has viewed the advertisement may be determined based on, for example, behavior information of the user. The effect measurer may measure the presence or absence and degree of advertising effect based on aggregated information. The effect measurer may further acquire and aggregate information such as whether the user has visited the advertised shop or purchased the advertised product.

Although the customer transport device is an elevator in the above-described third embodiment, the customer transport device may also be another device, for example, an escalator or moving sidewalk (hereinafter referred to as an escalator or the like). When the customer transport device is an escalator or the like, for example, digital signage (flexible light-emitting diodes (LEDs) for the inner deck) including flexible LEDs installed on a side of a belt held by users in the escalator or the like may be used as the display device. Alternatively, digital signage (transparent LED signage for a handrail) installed on a side panel supporting a rail of the belt held by users in the escalator or the like may be used as the display device. Moreover, when the customer transport device is an escalator or the like, the first acquirer 121 may determine the user's intention to view the digital signage or the user terminal 20 based on an image of the user P captured by the in-shop camera 11.

### Fourth Embodiment

Next, a fourth embodiment will be described. Recently, payment methods have become more diverse and payments using two-dimensional codes, UWB, NFC, and the like have been put into practical use in addition to cash payments. In these payments, it is necessary to identify the user who makes the payment.

On the other hand, if it takes much time and effort to identify the user, there is a concern that the convenience for the user may be reduced. Therefore, there is a need to accurately identify the user while minimizing the time and effort required for the user. The information processing device according to the fourth embodiment can be used for such payments.

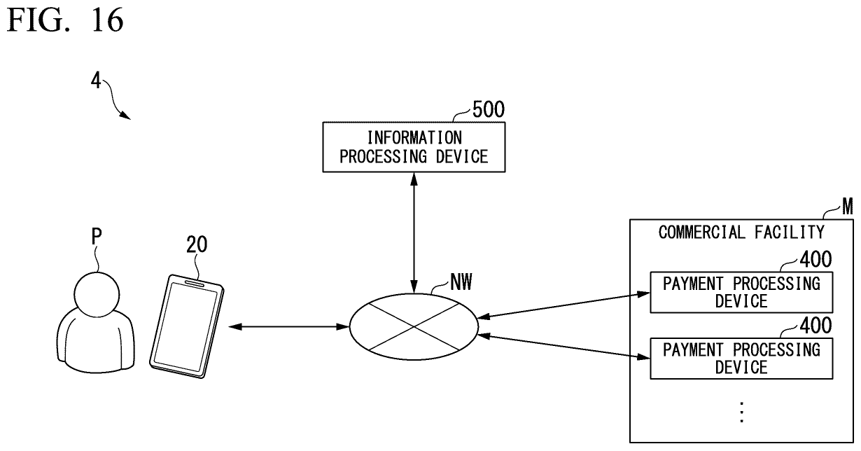

FIG. 16 is a diagram showing an example of a payment processing system 4 including the information processing device according to the fourth embodiment. The payment processing system 4 includes, for example, a user terminal 20, a plurality of payment processing devices 400, and an information processing device 500. The payment processing device 400 is installed within a commercial facility M and communicates with the information processing device 500 installed outside the commercial facility M via a network NW. The user terminal 20 is possessed, for example, by a user P.

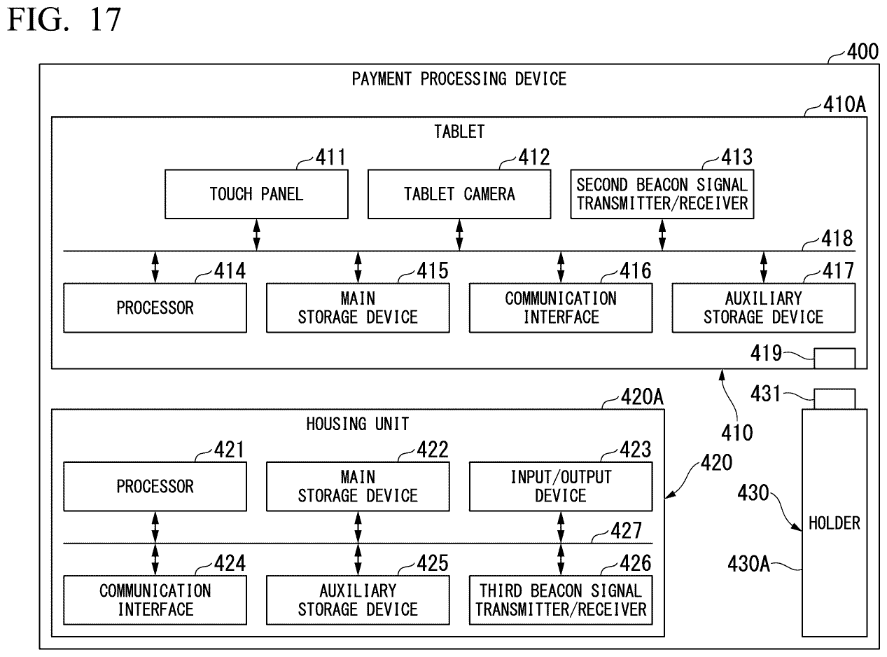

FIG. 17 shows an example of a hardware configuration of the payment processing device 400 according to the fourth embodiment. The payment processing device 400 includes, for example, a tablet 410, a housing unit 420, and a holder 430.

The tablet 410 includes, for example, a tablet housing 410A, a touch panel 411, a tablet camera 412, a second beacon signal transmitter/receiver 413, a processor 414, a main storage device 415, a communication interface 416, an auxiliary storage device 417, a bus 418, a tablet housing 410A, and a first connector 419. The tablet camera 412 is an example of an imaging device. These have configurations similar to those of the tablet housing 40A, the touch panel 41, the tablet camera 42, the second beacon signal transmitter/receiver 43, the processor 44, the main storage device 45, the communication interface 46, the auxiliary storage device 47, the bus 48, the tablet housing 40A, and the first connector 49 in the tablet 40 according to the first embodiment.

The housing unit 420 includes, for example, a housing 420A, a processor 421, a main storage device 422, an input/output device 423, a communication interface 424, an auxiliary storage device 425, a third beacon signal transmitter/receiver 426, and a bus 427. The processor 421, the main storage device 422, the input/output device 423, the communication interface 424, the auxiliary storage device 425, the third beacon signal transmitter/receiver 426, and the bus 427 are housed in the housing 420A. The processor 421, the main storage device 422, the input/output device 423, the communication interface 424, the auxiliary storage device 425, the third beacon signal transmitter/receiver 426, and the bus 427 have configurations similar to those of the processor 51, the main storage device 52, the input/output device 53, the communication interface 54, the auxiliary storage device 55, the third beacon signal transmitter/receiver 56, and the bus 57 according to the first embodiment.

The holder 430 includes a holder body 430A and a second connector 431. The holder body 430A of the holder 430 and the second connector 431 have configurations similar to those of the holder body 60A of the holder 60 and the second connector 61 according to the first embodiment.

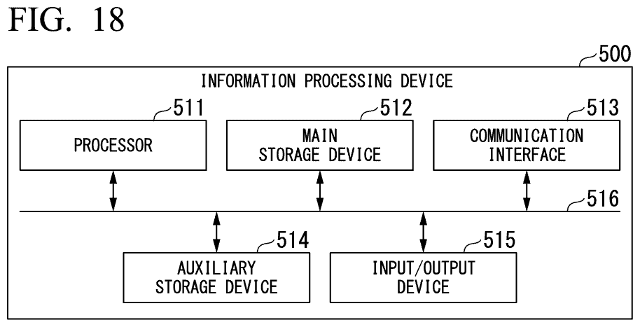

FIG. 18 is a diagram showing an example of a hardware configuration of an information processing device 500 according to the fourth embodiment. The information processing device 500 includes, for example, a processor 511, a main storage device 512, a communication interface 513, an auxiliary storage device 514, an input/output device 515, and a bus 516. The processor 511, the main storage device 512, the communication interface 513, the auxiliary storage device 514, and the input/output device 515 have configurations similar to those of the processor 81, the main storage device 82, the communication interface 83, the auxiliary storage device 84, the input/output device 85, and the bus 86 according to the first embodiment.

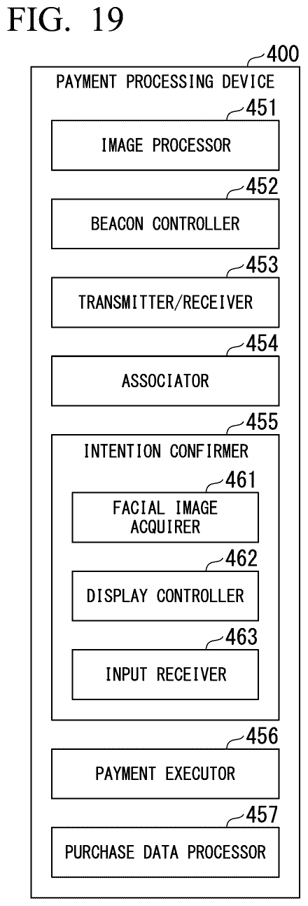

FIG. 19 is a diagram showing an example of a functional configuration of the payment processing device 400 according to the fourth embodiment. The payment processing device 400 includes, for example, an image processor 451, a beacon controller 452, a transmitter/receiver 453, an associator 454, an intention confirmer 455, a payment executor 456, and a purchase data processor 457.

The image processor 451 acquires image information of an image including a facial image of the user P's face (hereinafter referred to as a “face-including image”) transmitted by the tablet camera 412. The image processor 451 identifies and extracts a part of the user's face from the acquired image information. The beacon controller 452 has a configuration similar to that of the second beacon controller 310 according to the first embodiment.

The transmitter/receiver 453 transmits the image information acquired by the image processor 451 and the relative position information generated by the beacon controller 452 to the information processing device 500. The associator 454, for example, associates the payment processing device 400 with the user terminal 20 possessed by the user P as the user terminal 20 that will perform a payment based on association information transmitted by the information processing device 500. The association between the user terminal 20 and the payment processing device 400 will be further described after the description of the association information.

The intention confirmer 455 includes, for example, a facial image acquirer 461, a display controller 462, and an input receiver 463. The facial image acquirer 461 acquires a face-including image of the user P after a fog removal process of the image processor 451 is performed. When the user makes a payment, the display controller 462 generates a face-extracted image by extracting the user's face from the face-including image acquired by the facial image acquirer 461. The display controller 462 causes the touch panel 411 of the tablet 410 to display the generated face-extracted image.

When the face-extracted image is displayed, the display controller 462 causes the touch panel 411 to display an intention confirmation switch along with the face-extracted image. The intention confirmation switch can be operated, for example, by the user P's touch, and is, for example, a GUI containing text “OK” or “NG.” If the user P operates the intention confirmation switch displayed on the touch panel 411, the tablet 410 transmits approval information indicating whether or not the user P has approved the payment to the information processing device 500.

In place of or in addition to the display controller 462 that causes the intention confirmation switch to be displayed, a physical button may be designated as the confirmation switch used to confirm the intention to pay. For example, the position of the designated button may be displayed on the touch panel 411 or a lamp located near the designated button may be illuminated.

The input receiver 463 receives an input of approval information transmitted by the tablet 410 when the user operates the intention confirmation switch displayed on the touch panel 411 by the display controller 462. When the intention confirmation switch is a physical button, the input receiver 463 receives the input of approval information output by the physical button. When the input receiver 463 receives the approval information, the user P's intention to purchase is confirmed.

The payment executor 456 executes the payment for the product purchased by the user P when the user P's intention to purchase is confirmed. The payment executor 456 may also issue an electronic receipt after the payment for the product is completed. The payment executor 456 generates payment completion data on the condition that the payment is completed.

The purchase data processor 457 generates purchase data obtained by associating the payment completion data generated by the payment executor 456 with the user ID of the user P whose intention to purchase has been confirmed. The purchase data includes information about the product purchased by the user P, the shop (the shop selling the product), the time of purchase, the payment method used for the payment, and the like. The purchase data processor 457 transmits the generated purchase data to the information processing device 500.

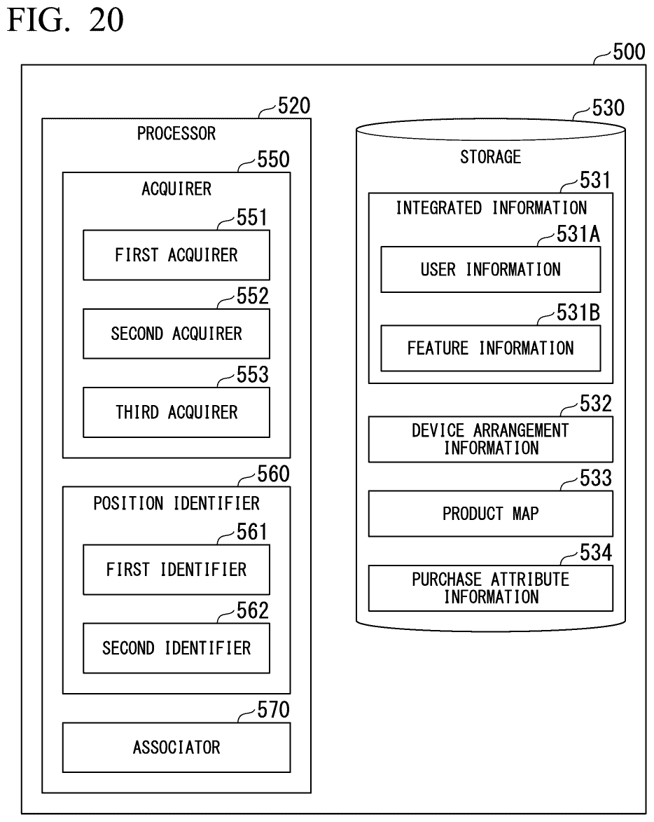

FIG. 20 is a diagram showing an example of a functional configuration of an information processing device 500 according to the fourth embodiment. The information processing device 500 includes, for example, a processor 520 and a storage 530. The processor 520 includes, for example, an acquirer 550, a position identifier 560, and an associator 570. The acquirer 550 includes, for example, a first acquirer 551, a second acquirer 552, and a third acquirer 553. The position identifier 560 includes a first identifier 561 and a second identifier 562.

The first acquirer 551 in the acquirer 550 acquires image information, which is user image information transmitted by the tablet camera 412. Based on the acquired image information, the first acquirer 551 performs a process similar to that of the first acquirer 121 in the first embodiment and assigns a user detection ID to the user P. When a plurality of users are detected in the image, a user detection ID is assigned to each of the plurality of users.

The second acquirer 552 acquires user information transmitted by the user terminal 20. When there are a plurality of users around the payment processing device 400, the user information transmitted by each of the plurality of users' user terminals 20 is acquired. In the fourth embodiment, the user ID included in the user information is used at the time of the payment. The third acquirer 553 acquires purchase data transmitted by the payment processing device 400.

The first identifier 561 in the position identifier 560 calculates a position of the user P based on the image information transmitted by the tablet camera 412. The first identifier 561 identifies the calculated position as the first calculated position. When a plurality of users are detected, the first position of each user is calculated. Because the position of the tablet camera 412 is an absolute position, the first calculated position becomes an absolute position.

The second identifier 562 calculates the relative position of the user P for the payment processing device 400 based on the relative position information transmitted by the beacon controller 452 or the user terminal 20 and information about the absolute position of the payment processing device 400 (the tablet 410). The second identifier 562 identifies the absolute position of the user P as the second calculated position based on the calculated relative position of the user P for the payment processing device 400 and the absolute position of the payment processing device 400.

The associator 570 associates the user detection ID assigned to the user by the first acquirer 551 with the user ID acquired by the second acquirer 552 based on the first calculated position identified by the first identifier 561 and the second calculated position identified by the second identifier 562. The associator 570 generates association information including the user ID and the user detection ID in association with each other. When there are a plurality of users, the associator 570 generates association information by associating the user ID and the user detection ID for each user. The associator 570 transmits the generated association information to the payment processing device 400 having transmitted the relative position information.

The storage 530 stores, for example, integrated information 531, device arrangement information 532, a product map 533, and purchase attribute information 534. The integrated information 531 includes user information 521A and feature information 521B. The integrated information 531, the device arrangement information 532, and the product map 533 have content similar to that of the integrated information 171, the device arrangement information 172, and the product map 173 in the first embodiment.

Purchase attribute information is information about the user's purchase attributes. The purchase attributes include, for example, some or all of the purchase data and other information, and, for example, includes information about a purchased product, a shop where the product was purchased, a time of the purchase, a payment method used for the payment, a used payment terminal, and the like. The purchase attribute information is generated and updated, for example, based on the purchase data transmitted by the payment processing device 400.

The associator 454 in the payment processing device 400, which has acquired the association information transmitted by the associator 570 in the information processing device 500, assigns the user ID included in the association information to the user P who is identified by the user detection ID included in the acquired association information. The associator 454 associates the user terminal 20 possessed by the user P to which the user ID has been assigned with the payment processing device 400 as the user terminal to be used for the payment.

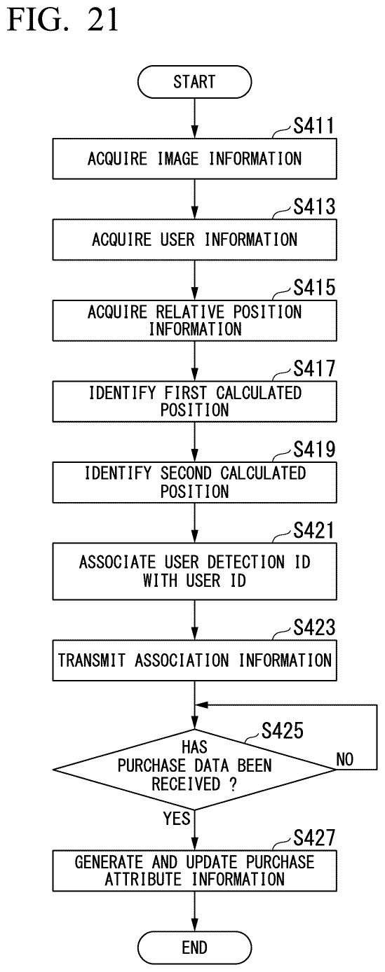

Subsequently, a process of the information processing device 500 according to the fourth embodiment will be described. FIG. 21 is a flowchart showing an example of the process of the information processing device 500 according to the fourth embodiment. In the information processing device 500 according to the fourth embodiment, the first acquirer 551 first acquires image information transmitted by the tablet camera 412 (step S411).

Subsequently, the second acquirer 552 acquires user information including a user ID transmitted by the user terminal 20 (step S413). Subsequently, the second identifier 562 acquires relative position information transmitted by the beacon controller 452 or the user terminal 20 (step S415).

Subsequently, the first identifier 561 calculates a position of the user P based on the image information transmitted by the tablet camera 412 and identifies the calculated position as a first calculated position (step S417). Subsequently, the second identifier 562 identifies a second calculated position, which is an absolute position of the user P, based on the acquired relative position information and information about an absolute position of the payment processing device 400 (step S419).

Subsequently, the associator 570 associates a user detection ID assigned to a user by the first acquirer 551 with the user ID acquired by the second acquirer 552 (step S421). Subsequently, the associator 570 generates association information and transmits the generated association information to the payment processing device 400 having transmitted the relative position information (step S423).

Subsequently, the third acquirer 553 determines whether or not purchase data transmitted by the payment processing device 400 having transmitted the association information has been acquired (step S425). When it is determined that the purchase data has not been acquired, the third acquirer 553 iterates the processing of step S425. When it is determined that the purchase data has been acquired, the third acquirer 553 generates purchase attribute information 534 based on the acquired purchase data and stores the purchase attribute information in the storage 530, or updates the purchase attribute information 534 stored in the storage 530 (step S427). In this way, the information processing device 500 ends the process shown in FIG. 21.

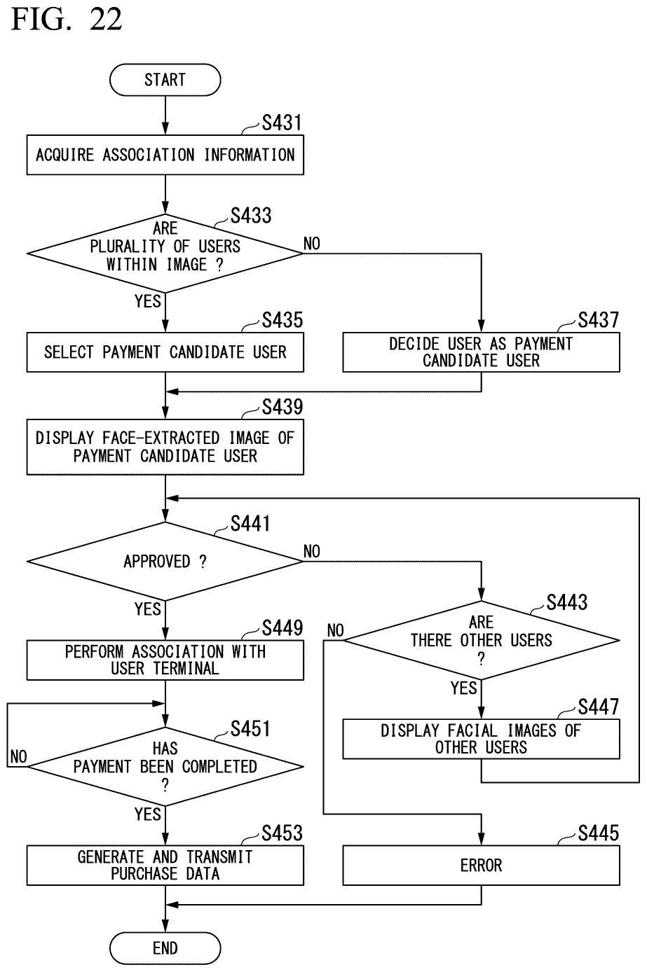

Next, the process of the payment processing device 400 to which the association information has been transmitted by the information processing device 500 will be described. FIG. 22 is a flowchart showing an example of the process of the payment processing device 400. The payment processing device 400 first acquires the association information transmitted by the information processing device 500 in the associator 454 (step S431).

Subsequently, the facial image acquirer 461 in the intention confirmer 455 determines whether or not there are a plurality of users in a face-including image captured by the tablet camera 412 (step S433). When it is determined that the face-including image contains a plurality of users, the facial image acquirer 461 selects a user who is a candidate for making a payment (hereinafter, a payment candidate user) (step S435).

The facial image acquirer 461 may select the payment candidate user in any way. For example, the user closest to the payment processing device 400 may be set as the payment candidate user, or the user facing the payment processing device 400 may be set as the payment candidate user. When it is determined that the face-including image does not include a plurality of users, the facial image acquirer 461 decides the user in the face-including image as the payment candidate user (step S437).

Subsequently, the display controller 462 generates a face-extracted image by extracting the face of the payment candidate user from the face-including image captured by the tablet camera 412 and causes the touch panel 411 to display the face-extracted image along with an intention confirmation switch (step S439). The payment candidate user checks the face-extracted image displayed on the touch panel 411 and operates the intention confirmation switch according to whether or not the payment candidate user is a person to make the payment. The tablet 410 transmits approval information corresponding to the operation of the intention confirmation switch to the intention confirmer 455.

Subsequently, the intention confirmer 455 determines whether or not the payment candidate user has approved the payment based on the approval information in the input receiver 463 (step S441). When the input receiver 463 determines that the payment candidate user has not approved the payment, the display controller 462 determines whether or not there are any other users who are not payment candidate users among users included in the face-including image (step S443). When it is determined that there are no other users, the display controller 462 determines that payment cannot be made and causes the touch panel 411 to display an error (step S445). In this way, the payment processing device 400 ends the process shown in FIG. 22.

On the other hand, when it is determined that there are other users, the display controller 462 generates a face-extracted image of the other user and causes the touch panel 411 to display the face-extracted image (step S447), and returns the process to step S441. When the input receiver 463 determines that the payment candidate user has approved the payment in step S441, the associator 454 associates the user detection ID of the payment candidate user with the user ID (step S449) and identifies the payment candidate user as the user P, who will make the payment.

Subsequently, the payment executor 456 determines whether or not the user P has completed the payment (step S451). When it is determined that the user P has not completed the payment, the payment executor 456 iterates the processing of step S451. When the payment executor 456 determines that user P has completed the payment, the purchase data processor 457 generates purchase data and transmits the purchase data to the information processing device 500 (step S453). In this way, the payment processing device 400 ends the process shown in FIG. 22.

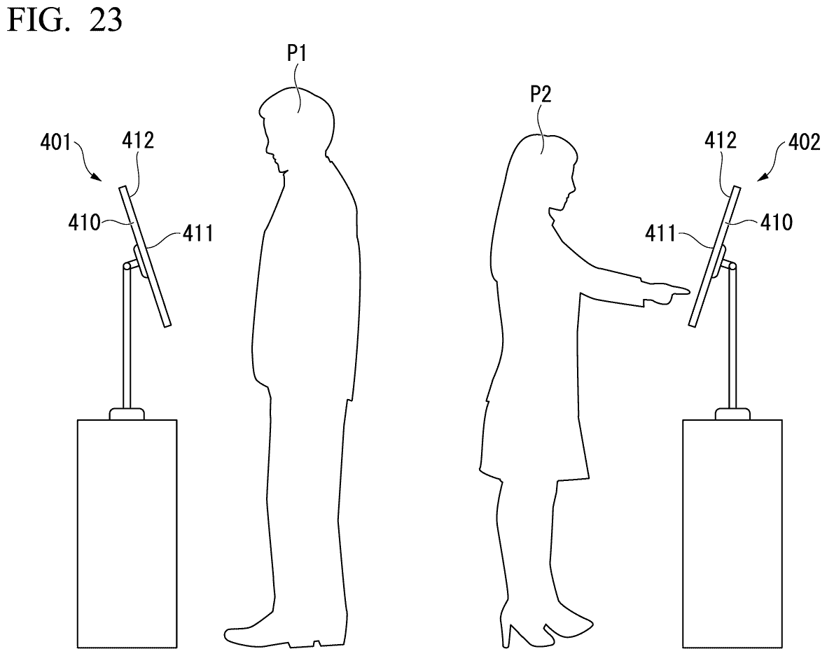

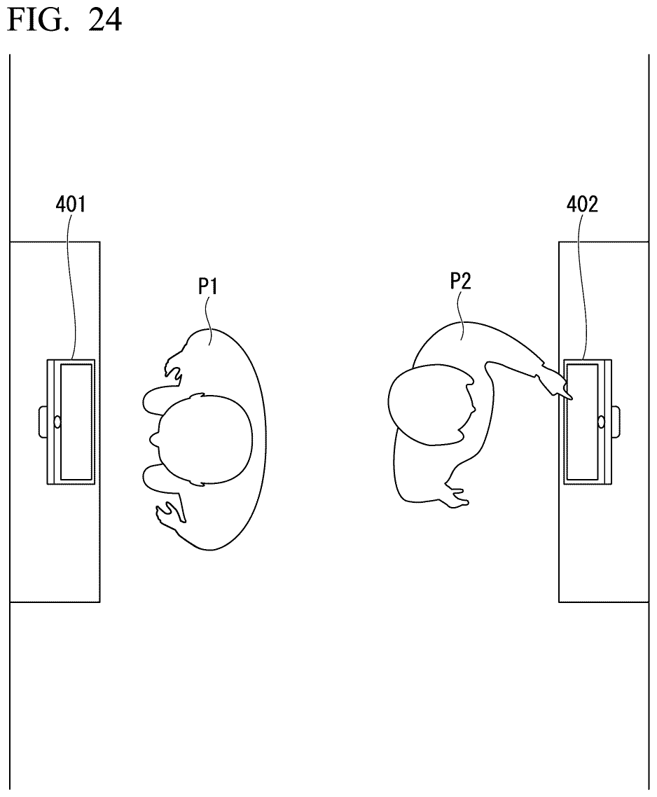

Next, operations of the payment processing device 400 and the user using the payment processing device 400 when a payment is made will be described. FIG. 23 is a view showing an example of a situation in which the user is making a payment using a payment processing device, viewed from the periphery. FIG. 24 is a view showing an example of a situation in which the user is making a payment using a payment processing device, viewed from the periphery.

In the examples shown in FIGS. 23 and 24, a first user P1 is attempting to make a payment using the first payment processing device 401, and a second user P2 is attempting to make a payment using the second payment processing device 402. Both the first payment processing device 401 and the second payment processing device 402 have the configuration shown in the payment processing device 400.

The first user P1 is facing the first payment processing device 401 and the second user P2 is facing the second payment processing device 402. The tablet camera 412 of the first payment processing device 401 images the face of the first user P1 and the back of the head of the second user P2 and the tablet camera 412 of the second payment processing device 402 images the face of the second user P2 and the back of the head of the first user P1. Both the first user P1 and the second user P2 are captured in the images captured by the tablet cameras 412 of the first payment processing device 401 and the second payment processing device 402.

The facial image acquirer 461 in the intention confirmer 455 of the first payment processing device 401 selects either the first user P1 or the second user P2 as a payment candidate user because the heads (faces and backs of the heads) of the first user P1 and the second user P2 are captured in the face-including image. The facial image acquirer 461 selects, for example, the first user P1, whose face is captured instead of the back of the head, as a payment candidate user. Likewise, the facial image acquirer 461 in the second payment processing device 402 selects, for example, the second user P2, whose face is captured instead of the back of the head, as a payment candidate user.

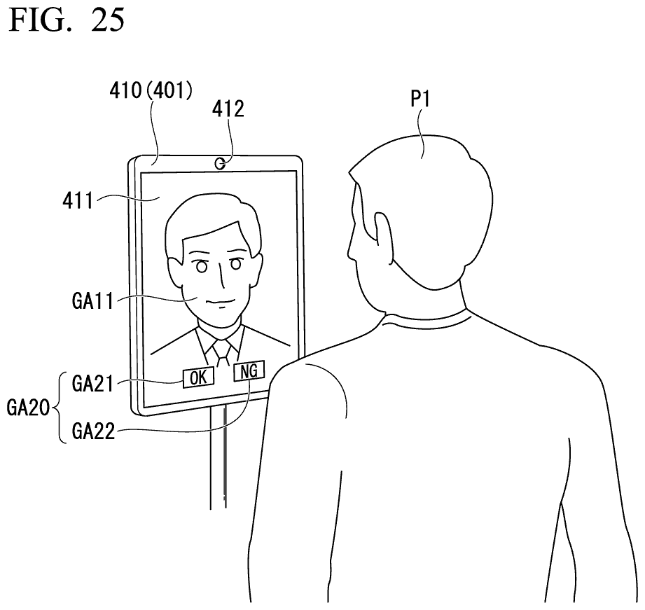

The display controller 462 of the first payment processing device 401 extracts the face of the first user P1 from the face-including image, generates a face-extracted image, and causes the touch panel 411 of the tablet 410 to display the face-extracted image. FIG. 25 is a view showing an example of a situation in which the first user P1 is gazing at the tablet 410 displaying the face-extracted image.

A face-extracted image GA11 of the first user P1 is displayed in the center of the touch panel 411 and an intention confirmation switch GA20 is displayed below the touch panel 411. The intention confirmation switch GA20 includes an approval switch GA21 and a denial switch GA22. The approval switch GA21 and the denial switch GA22 are displayed side by side, text “OK” is displayed on the approval switch GA21, and text “NG” is displayed on the denial switch GA22.

When the intention confirmation switch GA20 is displayed, a message such as “Do you want to pay?” may be transmitted from a speaker on the tablet 410. The first user P1 checks his or her own face displayed on the touch panel 411 and operates the approval switch GA21 when he or she is the person making the payment and operates the denial switch GA22 when he or she is not the person making the payment. The tablet 410 acquires confirmation information corresponding to the switch operated in the intention confirmation switch GA20 and causes a payment procedure to be executed.

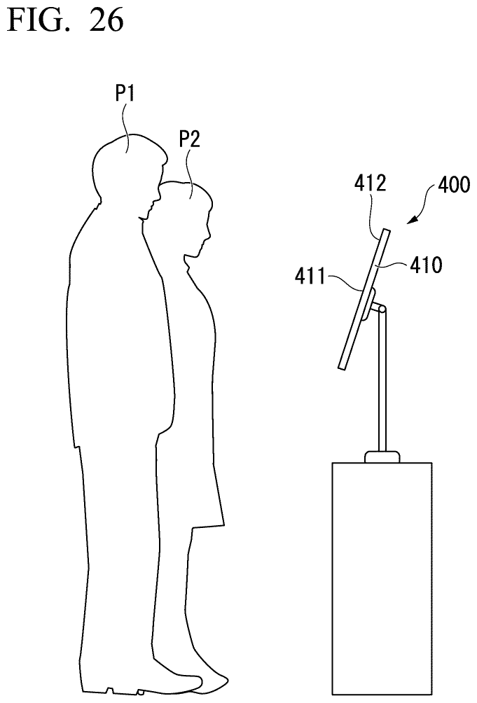

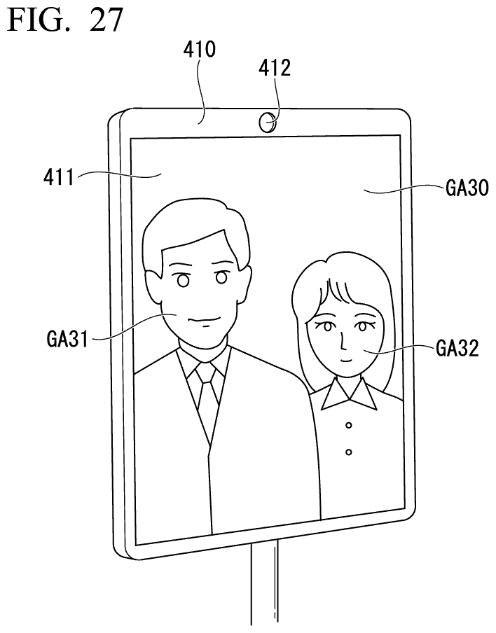

FIG. 26 is a view showing an example of another situation in which a user makes a payment using the payment processing device, viewed from the periphery. In the example shown in FIG. 26, for example, the second user P2 is the companion of the first user P1, and the first user P1 is about to make a payment using the payment processing device 400. Both the first user P1 and the second user P2 are facing the payment processing device 400.

FIG. 27 is a view showing an example of a face-including image GA30 captured by the tablet camera 412. In the face-including image GA30, a face-including image including a facial image GA31 of the first user P1 and a facial image GA32 of the second user P2 is captured. The face-including image GA30 is displayed on the touch panel 411 by the display controller 462 in the intention confirmer 455.

The facial image acquirer 461 selects either the first user P1 or the second user P2 as the payment candidate user. For example, the facial image acquirer 461 selects the first user P1 or the second user P2, who is closer to the payment processing device 400, here, the first user P1, as the payment candidate user.

The display controller 462 extracts the selected facial image GA31 of the first user P1 from the face-including image to generate a face-extracted image GA11. As shown in FIG. 25, the display controller 462 causes the touch panel 411 of the tablet 410 to display the generated face-extracted image GA11. The intention confirmation switch GA20 similar to that of the first payment processing device 401 is displayed on the touch panel 411. Thereafter, the process is performed in a procedure similar to that described for the first payment processing device 401.

The information processing device 500 according to the fourth embodiment has functions and effects similar to those of the first embodiment. Furthermore, the information processing device 500 according to the fourth embodiment uses association information generated by the associator 570 of the information processing device 500 in the selection of the user when a payment is performed in the payment processing device 400 and the intention confirmation of the user at the time of the payment. Thus, a process of associating the user P making a payment with their user terminal 20 and the payment processing device 400 can be performed with high accuracy through simple operations. For example, the user P can make a payment without removing the user terminal 20 from a bag or the like.

The information processing device 500 according to the fourth embodiment generates purchase attribute information in a state in which the user detection ID is associated with the user ID. Therefore, information about the user's actions (including behavior) in the shop can be generated based on the user detection ID and associated with the purchase attribute information. Therefore, when advertising information is generated, it is possible to accurately create information suitable for the user and perform highly accurate marketing analysis.

Furthermore, for example, it is possible to acquire user attribute information for a user who makes a payment by cash or the like without using a user terminal. Moreover, a shop where the payment processing device 400 is installed can acquire purchase data associated with the user ID of the user P and enable highly accurate marketing with reference to the purchase attribute information of the user P who has purchased a product from the shop and can provide or share only the purchase attribute information extracted from the purchase data with other shops.

Although the intention of the user P is confirmed based on an operation of the user P for the intention confirmation switch GA20 in the fourth embodiment, the intention of the user P may also be confirmed in other ways. The intention of the user P may be confirmed, for example, based on waving or nodding of the user P, or based on gazing of the user P at the screen of the touch panel 411 for a certain period of time.

Although the information processing device 500 is provided separately from the payment processing device 400 and is capable of communicating with the payment processing device 400 via the network NW in the fourth embodiment, some or all of the functions of the information processing device 500 may be included within the payment processing device 400. The information processing device 500 may be provided within the commercial facility where the payment processing device 400 is located or may be provided in a management center or the like away from the commercial facility.

### Fifth Embodiment

Next, a fifth embodiment will be described. An information processing device 100 according to the fifth embodiment includes a configuration in which the permission of a user P is obtained as a prerequisite for executing some or all of information for use in the processes of the acquirer 120, the position identifier 130, the feature information generator 140, and the generator 150 described in the above-described embodiments.

For example, when the permission is obtained from the user P, the information processing device 100 can acquire image information of the user P acquired using a camera (an in-shop camera 11, an in-elevator camera 16, and a tablet camera 412) and can execute some or all of a series of processes such as a process for analyzing the image information, a process for determining the position of the user P based on position information of the user P, and a process of associating the user detection ID with the user ID. In this case, the information processing device 100 acquires permission setting information of the user P for the process performed by a processor 110. The acquired permission setting information is stored in a storage 170. The processor 110 of the information processing device 100 performs information processing by excluding information other than permitted information based on the permission setting information from the information processing. In other words, the processor 110, for example, performs the information processing using only the permitted information based on the permission setting information from integrated information 171.

The permission setting information is, for example, information in which the permitted information capable of being used by the user P is set. The permission setting information may be, for example, information permitted in advance by the user P before or after the user P enters a commercial facility M, or information permitted by the user P when the permission is obtained from the user P every time information is to be processed. The usage setting information, for example, may define that the user permits the processing of information that the user does not deny to use and may be the information indicating that the user P does not deny to use as a result of asking the user about whether or not to deny every time information is to be processed.

The permission setting information may, for example, be included in user information 171A or feature information 171B as a part of the integrated information 171. For example, the permission setting information may be included in user information when previously set or included in feature information when permission is obtained from the user every time the information is used. The permission setting information may be stored in the storage 170 independently of the integrated information 171.

A method by which the information processing device 100 acquires the permission setting information is not particularly limited, and the information processing device 100 may acquire the permission setting information in any way. For example, the information processing device 100 may acquire permission setting information for information about the user P when the user P accesses the Internet in accordance with an operation of the input/output device 25 of the user terminal 20 and input necessary information on a specific website. Alternatively, the permission setting information may be set (stored) in the user terminal 20 in accordance with an operation of the input/output device 25 of the user terminal 20 by the user P, and the information processing device 100 may acquire the permission setting information as a part of the user information transmitted from the user terminal 20.

The processor 110 of the information processing device 100 determines whether or not the information to be processed has been permitted by the user P, for example, based on the permission setting information stored in the storage 170. The information processing device 100 performs a series of processes of the processor 110 described using FIGS. 9, 21, and 22 by focusing on the permitted information about the user P (the user terminal 20 possessed by the user P). Specifically, for example, when it is determined whether the calculated position of the user P is included in the video analysis area (step S119), it is also determined whether the information to be used for video analysis is information permitted by the user based on the permission setting information included in the integrated information 171, and behavior information of the user P for whom permission has been set is acquired (S125).

In other words, behavior information for the user P who has not permitted the acquisition of the behavior information in the information processing device 100 is not acquired. Furthermore, the subsequent association of the user detection ID with the user ID for only the user P who has set permission of the association of the user detection ID with the user ID (S127), the estimation of the target of interest (S129), and the generation and provision of the provision information and advertising information (S131 and S133) may be performed.

The information processing device according to the fifth embodiment has functions and effects similar to those of the information processing device 100 according to the first embodiment. Furthermore, according to the information processing device of the fifth embodiment, because only information permitted by the user P is processed, it is possible to consider the user P's privacy. Also, because a process such as the acquisition of behavior information or the association of the user detection ID with the user ID for the user P that has not given the permission is not performed, the computational load on the information processing device 100 for analyzing the user P's video and associating the user detection ID with the user ID can be reduced.

In the information processing device according to the fifth embodiment described above, the determination based on the permission setting information may be made at an earlier stage. That is, in the information processing device according to the fifth embodiment, after entry information and image information are acquired (S101), it is determined whether or not the user P has permitted the use of image information for video analysis based on permission setting information included in integrated information 171 stored in storage 170 and each of a process for generating a trained model (S103), a process for generating feature information (S109), a process for acquiring relative position information (S115), and a process for identifying a second calculated position (S117) may be performed by focusing on information about the user P having set the permission. By using this permission setting information in this way, it is possible to suppress an increase in the computational load of various processes performed by processor 110.

Furthermore, in the information processing device according to the fifth embodiment, the user P may be able to customize the data to be permitted in detail. For example, the user P may individually set the information to be permitted so that the data use of position information of the user P is permitted but the data use of behavior information and facial information is not permitted or so that the position information and the behavior information are permitted but only the facial information is not permitted, and the information processing device 100 (processor 110) may process the permitted information (data) within the scope of the permitted information (data). Moreover, these permission/non-permission settings are not limited to the operation of the user P for the user terminal 20 or a required input performed on a predetermined site on the web, and may be determined by the information processing device 100 (the processor 110) based on the user P's gestures according to a video analysis process on images acquired from a camera (the in-shop camera 11, the in-elevator camera 16, and the tablet camera 412).

### Sixth Embodiment

Next, a sixth embodiment will be described. An information processing device according to a sixth embodiment determines whether or not a plurality of users P form a group, for example, when their user IDs and user detection IDs are associated. A group may have any relationship, and may be, for example, a family (with infants or children), friends, a couple, or an elderly couple. An attribute such as whether the group is family or friends and a relationship between users (hereinafter, “members”) within the group are estimated, for example, by the information processing device.

In the sixth embodiment, the integrated information 171 includes group information about the group's composition, such as the users' family structure or friendship. The group information includes, for example, information about user IDs of group members and the group's attributes. For example, a first group includes three members, i.e., first to third members, and an attribute of the group includes information of a “family with children” or the like. Information about the first to third members includes user ID information. The group information is, for example, included in the integrated information 171 and stored in the storage 170. The user IDs of some of the members may be absent.

In the information processing device according to the sixth embodiment, the first acquirer 121 determines whether or not a plurality of detected users have formed a group based on whether they are within a certain distance for a certain period of time or more. For example, the first acquirer 121 determines that a plurality of users have formed a group when they have been within a 2-meter radius for three minutes or more.

When it is determined that a group has been formed, the first acquirer 121 identifies the user IDs of all group members. The first acquirer 121 determines whether group information including all of the determined user IDs has been stored in the storage 170. When the group information including all of the determined group members has not been stored in the storage 170, the first acquirer 121 generates group information with reference to user information 171A included in integrated information 171 and stores the group information in the storage 170 together with the integrated information 171. The first acquirer 121 is an example of a group information generator. The first acquirer 121 may generate the group information using information other than user information 171A, for example, information about a family structure and friendships provided directly from the user terminal 20 of the user P. The group information generator may be a functional unit other than the first acquirer 121, and, for example, may be the first generator 151 or a group information generator provided independently within the processor 110.

When the first acquirer 121 determines that a group has been formed, the first generator 151 generates user-targeted provision information, for example, an advertisement, for the determined group (hereinafter referred to as a target group). For example, the first generator 151 determines that the attributes of the group included in group information including all user IDs included in the target group are the attributes of the target group. The provider 160 provides the advertisement generated by the first generator 151 to the target group.

The first generator 151 generates advertising information according to the determined attributes of the group. For example, if the group attribute is a family, the first generator 151 generates advertising information suitable for the family, for example, information about family restaurants. For example, if the group attribute is children in the family, the first generator 151 generates advertising information suitable for the family with children, for example, information about toy departments. As in the first embodiment, the user-targeted provision information may be coupon information or the like.

The information processing device according to the sixth embodiment described above has functions and effects similar to those of the information processing device 100 according to the first embodiment. Furthermore, the information processing device according to the sixth embodiment generates user-targeted provision information, such as advertising information or coupon information according to the group attribute and provides the user-targeted provision information to the target group. Thus, it is possible to provide appropriate information to a plurality of users who form a group.

In the sixth embodiment described above, the first acquirer 121 may determine whether or not users have formed a group at any timing. For example, the first acquirer 121 may determine whether or not to form a group for all users within the commercial facility M at predetermined intervals, for example, every three minutes, or may determine whether or not to form a group for all users, excluding users who have already been determined to form a group, at similar timings. Alternatively, the first acquirer 121 may determine whether or not to form a group when the number of new users entering the commercial facility M has reached a specified number.

According to an embodiment, an information processing device includes: a first acquirer configured to acquire first information about a user based on first detection information detected by a first detection device; a second acquirer configured to acquire second information including second detection information detected by a second detection device and user identification information for identifying the user; a first identifier configured to identify a first calculated position of the user based on the first detection information; a second identifier configured to identify a second calculated position of the user based on the second detection information; and an associator configured to associate the user identification information with the first information based on the first calculated position and the second calculated position, whereby the position of the user can be easily identified.

While several embodiments of the present invention have been described above, these embodiments have been presented by way of example only, and are not intended to limit the scope of the inventions. These embodiments may be embodied in a variety of other forms. Various omissions, substitutions, and combinations may be made without departing from the spirit of the inventions. The inventions described in the accompanying claims and their equivalents are intended to cover such embodiments or modifications as would fall within the scope and spirit of the inventions.

What is claimed is:

1. An information processing device comprising:
a first acquirer configured to acquire first information about a user based on first detection information detected by a first detection device;
a second acquirer configured to acquire second information including second detection information detected by a second detection device and user identification information for identifying the user;
a first identifier configured to identify a first calculated position of the user based on the first detection information;
a second identifier configured to identify a second calculated position of the user based on the second detection information; and
an associator configured to associate the user identification information with the first information based on the first calculated position and the second calculated position.

2. The information processing device described in claim 1, wherein the second calculated position is calculated with a smaller computational load than the first calculated position.

3. The information processing device of claim 1, wherein
the first calculated position is calculated based on image information obtained by capturing an image of the user, and
the second calculated position is calculated based on relative position information about the relative position between a beacon and the user.

4. The information processing device of claim 1, wherein the first calculated position is calculated when the second calculated position is within a video analysis area.

5. The information processing device of claim 4, wherein the first information includes behavior information about a behavior of the user.

6. The information processing device of claim 1, wherein
the user includes a user of a commercial facility, and
the information processing device further comprises an estimator configured to estimate target-of-interest information about a target of interest of the user based on the first detection information.

7. The information processing device of claim 6, further comprising a first generator configured to generate user-targeted provision information to be provided to the user based on the target-of-interest information.

8. The information processing device of claim 7, wherein
the target-of-interest information includes product information about a product to be sold in the commercial facility, and
the user-targeted provision information includes at least one of auxiliary information for assisting in purchasing the product and advertising information about advertisements of the product.

9. The information processing device of claim 8, wherein the auxiliary information includes information about at least one of a coupon for the product, inventory for the product, related product information about the product, or an ancillary service associated with the product.

10. The information processing device of claim 8, wherein the advertising information is provided to at least one of a user terminal possessed by the user and signage installed at the commercial facility and located around the user.

11. The information processing device of claim 6, further comprising a second generator configured to generate employee-targeted provision information to be provided to an employee of the commercial facility based on the target-of-interest information.

12. The information processing device according to claim 11, wherein the employee-targeted provision information includes at least one of user identification information for identifying the user, position information indicating the position of the user, or the target-of-interest information.

13. The information processing device according to claim 5, wherein
the user includes a user of a commercial facility,
the behavior information includes putting-into-basket action information, and
the information processing device further comprises a product identifier configured to identify a purchase target product of the user based on the putting-into-basket action information.

14. The information processing device of claim 13, wherein the product identifier further identifies the purchase target product of the user based on a product displayed in a position where a weight applied to a display shelf has become lighter among a plurality of products displayed on the display shelf.

15. The information processing device of claim 3, further comprising:
a feature information generator configured to extract a feature of the user based on the image information and generate user feature information according to the extracted feature of the user,
wherein the associator associates the first information with the second information based on the user feature information.

16. The information processing device of claim 3, further comprising:
a learner configured to update a trained model trained by machine learning using an image of the user as input data and a likelihood of the user as output data.

17. The information processing device of claim 15, wherein the associator associates the first information with the second information based on the user feature information when the first information and the second information are not associated based on the first calculated position and the second calculated position.

18. The information processing device of claim 1, wherein the first acquirer confirms the user's intention to view an advertisement display medium based on the acquired first information, and causes an advertisement to be displayed on the advertisement display medium for which the intention to view has been confirmed.

19. An information processing method comprising:
acquiring, by a computer, first information about a user based on first detection information detected by a first detection device;
acquiring, by the computer, second information including second detection information detected by a second detection device and user identification information for identifying the user;
identifying, by the computer, a first calculated position of the user based on the first detection information;
identifying, by the computer, a second calculated position of the user based on the second detection information; and
associating, by the computer, the user identification information with the first information based on the first calculated position and the second calculated position.

20. A non-transitory computer-readable storage medium storing program for causing a computer to:
acquire first information about a user based on first detection information detected by a first detection device;
acquire second information including second detection information detected by a second detection device and user identification information for identifying the user;
identify a first calculated position of the user based on the first detection information;
identify a second calculated position of the user based on the second detection information; and
associate the user identification information with the first information based on the first calculated position and the second calculated position.
